(19) United States
(12) Patent Application Publication
(10) Pub. No.: US 2024/0419407 A1
(43) Pub. Date: Dec. 19, 2024

(54) PROTOTYPING APPLICATIONS OF SPATIALLY AWARE SMART OBJECTS USING AUGMENTED REALITY

(71) Applicant: City University of Hong Kong, Kowloon (HK)

(72) Inventors: Hongbo FU, Sha Tin (HK); Hui YE, Sha Tin (HK); Chufeng XIAO, Kowloon (HK)

(21) Appl. No.: 18/335,559

(22) Filed: Jun. 15, 2023

(51) Int. Cl. G06F 8/34; G06F 11/36

(52) U.S. Cl. CPC G06F 8/34; G06F 11/3684

(57) ABSTRACT

One or more devices, systems, methods and/or non-transitory, machine-readable mediums are described herein for prototyping applications of spatially aware smart objects using augmented reality (AR). In an embodiment, a system can comprise a memory that stores computer-executable components, and a processor that executes the computer-executable components stored in the memory. The computer-executable components comprise a spatial detection component that determines and tracks spatial positions and orientations of one or more objects in association with moving the one or more objects within a real-world environment, and an interface component comprising a visual programming user interface that facilitates prototyping spatial events and corresponding effects associated with the moving of one or more objects based on the relative spatial positions.

### BACKGROUND

Rapid advances in digital technologies have brought new interaction paradigms for digital devices, beyond the boundary of digital screens. In particular, emerging sensing technologies endow many digital devices (e.g., Internet of Things (IoT) devices, mobile phones, smart watches, tablet computers, etc.) with spatial awareness, which allows interactive spaces to react to the spatial movements and configurations of objects. By manipulating the proximity and spatial configurations of object(s), people can interact with them to facilitate natural and intuitive cognition. Thus, such spatially aware interactions have a wealth of applications from evoking and controlling screen-based functions using device movements to exchanging information among cross/networked devices using proximity.

Before the development stage, these applications are established from an iterative design cycle, where prototyping is a significant early-stage phase to enable designers to rapidly traverse and validate design ideas and concepts. Designers typically resort to traditional prototyping approaches such as making videos and paper mock-ups in their workflow. However, these approaches are difficult to depict the realistic and interactive aspects of spatially aware interactions for smart objects. Besides, heavy coding tasks are required to define dynamic and interactive spatially aware object interactions.

### SUMMARY

The following presents a summary to provide a basic understanding of one or more embodiments described herein. This summary is not intended to identify key or critical elements, or to delineate any scope of the particular embodiments and/or any scope of the claims. The sole purpose of the summary is to present concepts in a simplified form as a prelude to the more detailed description that is presented later.

One or more devices, systems, methods and/or non-transitory, machine-readable mediums are described herein for prototyping applications of spatially aware smart objects using augmented reality (AR). In an embodiment, a system can comprise a memory that stores computer-executable components, and a processor that executes the computer-executable components stored in the memory. The computer-executable components comprise a spatial detection component that determines and tracks relative spatial positions and orientations of one or more objects in association with moving the one or more within real-world (RW) environment, and an interface component comprising a visual programming user interface (UI) that facilitates prototyping spatial events and corresponding effects associated with the moving of one or more objects based on the relative spatial positions and orientations.

In one or more embodiments, the visual programming UI comprises an augmented reality (AR) UI that renders via a display of an AR device. In some implementations of these embodiments, the spatial detection component determines and tracks the relative spatial positions and orientations based on sensor data captured by one or more sensors that are part of, or communicatively coupled to, the AR device. For example, the spatial detection component can determine and track the relative spatial positions using one or more spatial positioning markers associated with the objects and a spatial positioning marker-based tracking process. In some implementations, the real-world environment comprises an environment within a field-of-view (FOV) of the display, and wherein the interface component renders the visual programming UI via the display in association with the moving of the objects within the environment.

The computer-executable components can further comprise a spatial event and effect creation component that generates spatial event information defining a spatial event corresponding to a defined spatial position or movement of the one or more objects, wherein the spatial event information is generated based on first user input received via the visual programming UI, and wherein the spatial event is defined based on the performance-based user's manipulation. The effect creation component further generates effect information defining an effect of the spatial event based on second user input received via the visual programming UI defining the effect. The event-effect mapping creation component generates an event-effect model associated with the moving of the one or more objects based on the spatial event information and the effect information from the third user input received via the visual programming UI.

In some implementations, the first user input indicates the spatial events based on a placement of the one or more objects at the target spatial behavior within the FOV of the display, and wherein the interface component generates a first virtual proxy representative of the spatial event and renders the virtual proxy via the display in association reception of the first user input. The interface component can also generate a second virtual proxy representative of the effect and renders the second virtual proxy via the display in association with reception of the second user input, and wherein the event-effect mapping creation component generates a mapping between the spatial event and the event effect within the event-effect model based on reception of third user input via the visual programming UI connecting the first virtual proxy to the second virtual proxy.

In this regard, the effect information defines the effect of a virtual asset (e.g., a virtual icon, image, symbol, etc.). In various embodiments, the effect information enables the control of a behavior of the virtual asset via the display in response to a detection of the spatial event. In some implementations, the virtual programming UI facilitates at least one of selecting the virtual asset from a group of predefined virtual assets or creating the virtual asset using one or more virtual asset creation tools.

In various embodiments, the moving corresponds to a first moving of the one or more objects performed in association with a creation mode of the visual programming UI, and wherein the computer-executable components further comprise a testing component that executes a testing mode of the visual programming UI using the AR device, wherein the testing mode facilitates testing of the spatial event and the effect in accordance with the event-effect model in association with one or more objects within the FOV of the display. With these embodiments, the spatial detection component determines and tracks updated spatial positions and orientations of the one or more objects, and wherein the interface component renders the virtual asset via the display in accordance with the event-effect model in response to the detection of the spatial event by the spatial detection component based on an updated relative spatial position and orientation.

According to yet another embodiment, a method can comprise determining and tracking, by a system comprising a processor, spatial positions and orientations of one or more objects in association with moving the one or more objects within a FOV of a display of an AR device, and rendering, by the system via the display, a visual programming UI that facilitates prototyping spatial events and corresponding effects associated with one or more objects. The method can further comprise generating, by the system, spatial event information defining a spatial event corresponding to a defined spatial position or movement of the one or more objects based on first user input received via the visual programming UI defining the spatial event. The method can further comprise generating, by the system, effect information defining an effect of the spatial event based on second user input received via the visual programming UI defining the effect, and generating, from the user's specification, an event-effect model associated with one or more objects based on the spatial event information and the effect information.

According to another embodiment, a non-transitory machine-readable medium, can comprise executable instructions that, when executed by a processor facilitate performance of operations, comprising determining and tracking spatial positions and orientations of one or more objects in association with moving the objects within a field-of-view of a display of an augmented reality device, and providing a visual programming UI via the display that facilitates prototyping spatial events and corresponding effects associated with one or more objects.

### DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout.

FIG. 1 illustrates a diagram of an example AR-based system that facilitates prototyping applications of spatially aware smart objects in accordance with an example usage scenario.

FIG. 2 presents a table defining a taxonomy of example input events and corresponding example output effects that may be defined by the spatial interaction model in accordance with one or more embodiments.

FIG. 3 illustrates examples of the single object discrete events triggered effects in accordance with one or more embodiments.

FIG. 4 illustrates examples of the single object continuous events and triggered effects in accordance with one or more embodiments.

FIG. 5 illustrates examples of the multiple object discrete events and triggered effects in accordance with one or more embodiments.

FIG. 6 illustrates an example AR system that facilitates prototyping applications of spatially aware smart objects in accordance with one or more embodiments described herein.

FIG. 7 presents a diagram of an example workflow for creating and testing an event-effect model for a spatial interaction between objects using an AR system in accordance with one or more embodiments.

FIG. 8 illustrates a hand menu of an example visual programming user interface that facilitates prototyping application of spatially aware smart object in accordance with one or more embodiments.

FIG. 9 illustrates an event menu an example visual programming user interface that facilitates prototyping application of spatially aware smart object in accordance with one or more embodiments.

FIGS. 10A-10H present example features of the visual programing UI in association with creation of different types of spatial events.

FIG. 11 illustrates an asset menu an example visual programming user interface that facilitates prototyping application of spatially aware smart object in accordance with one or more embodiments.

FIG. 12 illustrates an effect menu an example visual programming user interface that facilitates prototyping application of spatially aware smart object in accordance with one or more embodiments.

FIG. 13 presents a block diagram of another example, non-liming, computer-implemented method that facilitates prototyping applications of spatially aware smart objects in accordance with one or more embodiments.

FIG. 14 presents a block diagram of another example, non-liming, computer-implemented method that facilitates prototyping applications of spatially aware smart objects in accordance with one or more embodiments.

FIG. 15 presents a block diagram of another example, non-liming, computer-implemented method that facilitates prototyping applications of spatially aware smart objects in accordance with one or more embodiments.

FIG. 16 illustrates a block diagram of an example, non-limiting, operating environment in which one or more embodiments described herein can be operated.

FIG. 17 illustrates a block diagram of an example, non-limiting, cloud computing environment in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background section, Summary section or in the Detailed Description section.

As alluded to in the Background section, an important phase of design, prototyping such interactions still remains challenging, since there is no ad-hoc approach for emerging interactive paradigms. In this regard, emerging sensing technologies endow many digital devices (e.g., IoT devices, mobile phones, smart watches, tablets, etc.) with spatial awareness, which has enabled a wealth of applications based on interactions between such smart objects. For example, various applications have been developed that use input signals based on proximity and spatial movements of smart digital devices to control device functions, exchange information among cross/networked devices, and various others. In this regard, the term “spatially aware smart object” or more generally “smart object,” is used herein to refer to a digital object (e.g., an IoT device, a mobile phone, a smart watch, a laptop computer, etc.) with one or more functions (e.g., electrical functions, electromechanically functions, etc.) capable of being controlled (or configured to be controlled) using an input signal based on a spatial interaction of itself or between the object and another object or a spatial configuration, movement or orientation of the object.

Before the development stage, these applications are established from an iterative design cycle, where prototyping is a significant early-stage phase to enable designers to rapidly traverse and validate design ideas and concepts. Designers typically resort to traditional prototyping approaches such as making videos and paper mockups in their workflows. However, these approaches are difficult to depict the realistic and interactive aspects of spatially aware interactions for smart objects. In addition, these techniques require heavy coding tasks to define dynamic and interactive spatially aware object behaviors. Accordingly, these approaches have very high entry barriers and thus inhibit the design and prototyping of new applications based on spatially aware interactions of smart objects.

The disclosed subject matter is directed to systems, computer-implemented methods, apparatus and/or computer program products that facilitate prototyping applications of spatially aware smart objects using augmented reality (AR). AR refers to the integration of digital information with the user's real-world environment in real time. AR is used to either visually change natural environments in some way or to provide additional information to users. The primary benefit of AR is that it manages to blend digital and three-dimensional (3D) components with an individual's perception of the real world. AR delivers visual elements, sound and other sensory information to the user through an AR device that typically utilize sensors (e.g., cameras, motion sensors, and others) and a processor to capture and interpret information about the real-world environment and an AR display to render digital content over the user's current view of the environment as viewed on or through the AR display.

In one or more embodiments, the disclosed techniques provide a system that facilitates designing and testing spatially aware interactions of smart objects using an AR device, such as a wearable AR head-mounted display (HMD) device (also referred to as an AR headset), smart glasses, mixed reality headsets, AR glasses, AR contact lenses, mobile AR devices (e.g., smartphones, tablets, etc.), and others. For example, in some embodiments, the system can include or correspond to a smart object prototyping application configured for usage with an AR device capable of detecting and tracking spatial events of objects within a field-of-view (FOV) of a display of the AR device, receiving user input (e.g., via gesture recognition technology, voice recognition technology, and other types of input mechanism) and rendering digital content via the display over and/or relative to a current view of the objects as positioned within the FOV of the display. In various example embodiments, the disclosed techniques are described in association with utilization of an AR-HMD capable of receiving and processing gesture-based user input, however the disclosed techniques can be implemented using any type of AR device.

In one or more embodiments, the disclosed AR-based prototyping system facilitates creating and testing spatially aware interactions of smart objects in association with manipulating the objects in a real-world (RW) physical environment while viewing the objects/environment through the display of an AR device. The objects can include or correspond to digital objects that are or correspond to smart objects. The smart objects can also include non-digital objects (e.g., any non-digital physical object, such as pens, cups, toys, tabletops, doors, walls, buildings, etc.) that may be used to trigger an effect on a smart object based on its spatial interaction.

Generally, the AR-based prototyping system enables designers to obtain the spatial properties of smart objects, specify spatially aware interactions and/or behaviors of the objects from an input-output event triggering workflow, and test the prototyping results efficiently. More specifically, the AR-based prototyping system allows designers to obtain the six degrees of freedom (6-DoF) poses (i.e., 3D positions and 3D orientations) of one or multiple smart objects in real-time. Then designers follow an input-output event-driven workflow to specify the triggering spatial events by performing certain object interactions as input events and creating virtual assets or sketches with the specified effects as output effects. Finally, designers can test the prototyping interactions by manipulating the real-world objects easily and view the effects as represented by the virtual assets rendered via the AR device.

In this regard, the disclosed system allows users to prototype spatially aware interactions of real-world objects in real-world scenarios. The users can create and test interactive prototypes using the disclosed system by manipulating objects and author triggering events and effects in situ, without the requirements of programming skills.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

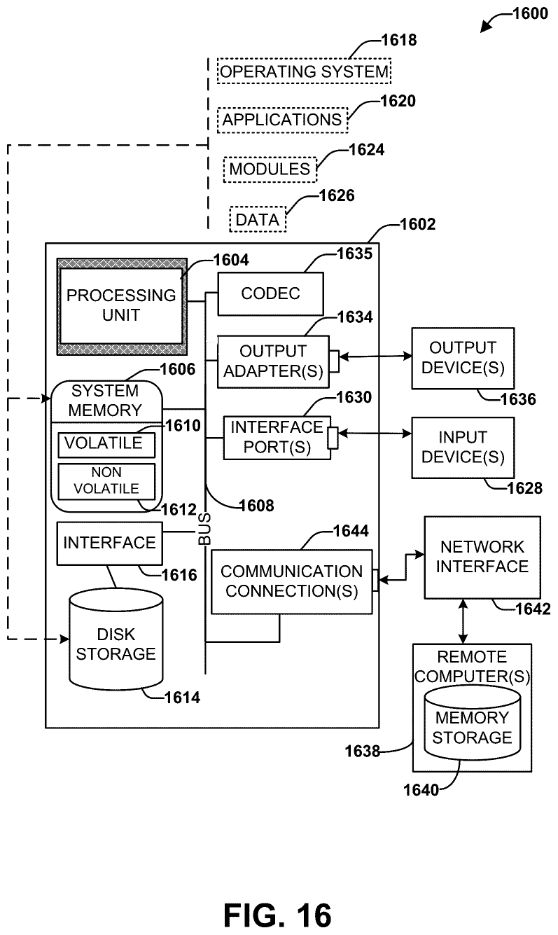

Further, it will be appreciated that the embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, one or more devices, systems and/or apparatuses thereof can further comprise one or more computer and/or computing-based elements described herein with reference to an operating environment, such as the operating environment 1600 illustrated at FIG. 16. In one or more described embodiments, computer and/or computing-based elements can be used in connection with implementing one or more of the systems, devices, apparatuses and/or computer-implemented operations shown and/or described in connection with one or more figures described herein.

As used herein, the terms “user,” “entity”, “user identity,” and the like can refer to a machine, device, component, hardware, software, smart device and/or human.

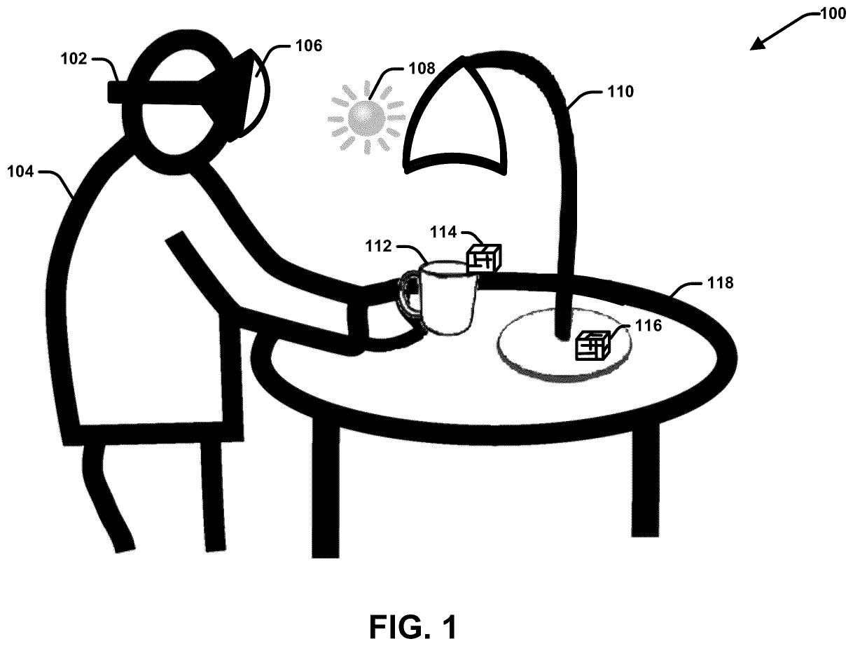

Turning now to the drawings, FIG. 1 illustrates a diagram of an example AR-based system 100 that facilitates prototyping applications of spatially aware smart objects in accordance with an example usage scenario. System 100 can comprise an AR-HMD that can enable a process to specify an event in an AR environment overlaying a RW environment and facilitate interaction between the two environments, in accordance with one or more embodiments described herein. While referring here to one or more processes, facilitations, and/or uses of the non-limiting system 100, description provided herein, both above and below, also can be relevant to one or more other non-limiting systems described herein, such as the non-limiting AR system 600, to be described below in detail.

Generally, a RW/AR interaction system as described herein can employ an AR device 102 that includes (or can be operatively coupled to) hardware and software that that can enable a process to generate an AR-based prototype of an application of a spatially aware smart object in a RW environment. For example, in the example usage scenario illustrated in FIG. 1, a user 104 is using the AR device 102 to prototype (e.g., design and create an exemplary demonstration model) of an application based on a spatial interaction between a cup 112 and a lamp 110 (e.g., a lamp with IoT capabilities). For instance, the application may correspond to an application for the lamp 110 via which one or more functions of the lamp 110 (e.g., turning on/off, changing brightness, changing color settings, etc.) can be controlled based one or more spatial interactions between the cup 112 and the lamp 110. In various embodiments and as illustrated in FIG. 1, the AR device 102 may comprise an AR-HMD that can be worn by a user 104 and operated in a hands-free manner to allow usage of the user's hands to manually move and position one or more objects (e.g., cup 112 and/or lamp 110) relative to one another in the RW environment while viewing the objects and the RW environment through a transparent or semi-transparent display 106 of the AR device 102. However, it should be appreciated that while one or more devices and/or systems are described with reference to use on wearable AR device, such as an AR-HMD, AR googles, AR glasses, AR contact lenses, and the like, the one or more embodiments described herein are not limited to this use and can also can be applicable to use by other types of AR devices having a display, built-in sensors, cameras, and/or the like.

In this regard, the AR device 102 can generally include (or be operatively coupled to) a display 106 capable of rendering AR content (e.g., a holographic display, a graphical display, etc.) over/relative to the user's view of the RW environment, one or more cameras and/or one or more built-in sensors (e.g., motion sensors, infrared sensors, etc.) capable of capturing sensory information about the RW environment regarding spatial properties of objects present in the RW environment, and hardware and software that enables processing the sensory information and performing a process that facilitates prototyping applications of spatially aware smart objects in RW scenarios using the AR device 102. In various embodiments, the software can include or correspond to an AR-based prototyping application configured for usage with an AR device such as AR device 102, hereinafter referred to as the “prototyping application”. In this regard, the prototyping application can enable the user 104 to create and test interactive prototypes of new applications based on spatial interactions between real objects using the AR device 102 by manipulating objects and author triggering events/effects in situ, without the requirements of programming skills.

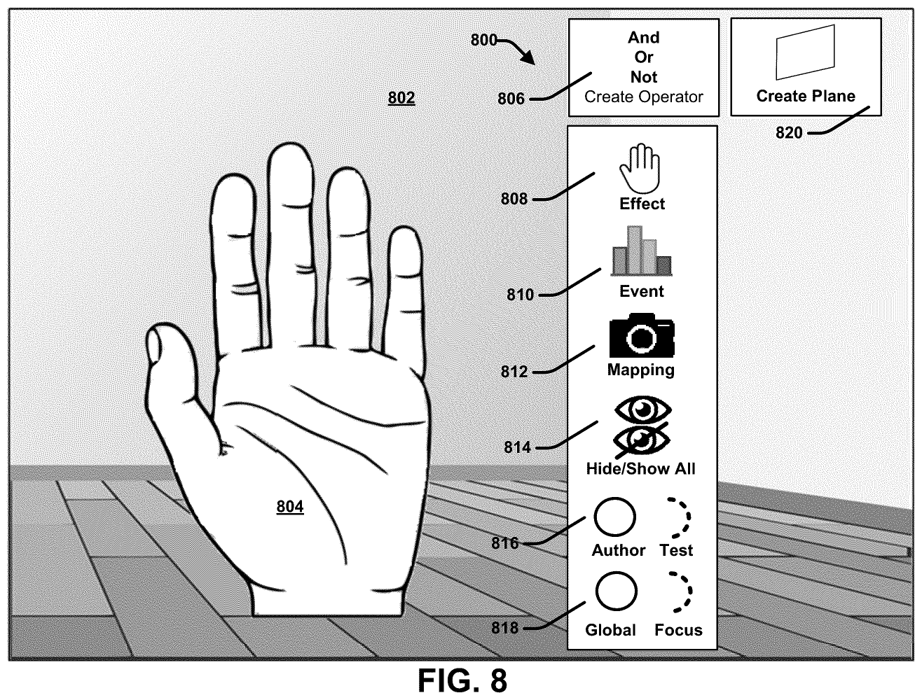

For example, in accordance with an example usage scenario illustrated in FIG. 1, the prototyping application can be configured to employ an AR marker-based tracking mechanism to determine and track the positions/orientations/distance of the cup 112 and the lamp 116 using AR markers 114 and 116 respectively associated with the objects in association with movement of the cup 112 relative to the lamp 110 about the RW environment (e.g., the surface of the table 118) by the user (e.g., or another entity) while the user views the objects relative to the RW environment on or through the display 106. Although not shown in FIG. 1, the prototyping application can present an interactive visual programming UI via the display 106 that can be seen from the perspective of the user 104 that can be utilized by the user to interact with the features and functionalities the prototyping application. For example, the interactive visual programming UI can include a graphical user interface (GUI) projected on the display 106, a holographic user interface projected via the display 106 into the RW environment, or another type of interactive AR user interface. In various embodiments, the user 104 can provide input via the interactive visual programming UI using gesture commands (e.g., interacting with holographic input buttons/widgets or the like presented to the user via the display) and/or verbal cues, however other input mechanisms are envisioned. Examples of the interactive visual programming UI are provided with reference to FIGS. 8-12 and described in greater detail infra.

In general, the features and functionalities the prototyping application include an authoring workflow which allows the user 104 to create and define spatial events corresponding to one or more spatial interactions of/between objects based on relative positions and/or movements of the objects, and create and define one or more effects triggered by the one or more spatial events that can be visualized via the display 106. For instance, in the example illustrated in FIG. 1, using the authoring workflow, the user 104 can move the cup 112 to a desired target position relative to the lamp 110 in association with prototyping a new spatially aware object application wherein placement of the cup 112 at the target position relative to the lamp 110 causes the lamp to turn on (or perform another user defined effect). For example, placement of the cup 112 at the target position relative to the lamp 110 can correspond to a spatial event that may be defined by the user 104 using the prototyping application. In this regard, using the prototyping application deployed on the AR device 102 (or another device communicatively coupled to the AR device 102), the user 104 can provide input (e.g., via the visual programming UI) setting the target position and thus the spatial event which can be tracked and determined by the prototyping application using the AR-markers 114 and 116 and one or more cameras and/or built-in sensors of the AR device (e.g., and an AR marker tracking algorithm).

The user 104 can further provide input setting a desired effect to occur in response to the spatial event (i.e., placement of the cup 112 at the target position relative to the lamp 110), such as turning the lamp on. To visualize the desired effect in situ, the prototyping application can allow the user to select and/or create an AR content/data (e.g., a virtual or holographic icon, image, etc.), referred to herein as a virtual asset, to be rendered via the display 106 representative of the effect. In this example, the user has selected a sun asset 108 to represent the effect, which is shown next to the lamp 110 for exemplary purposes. In this regard, it should be appreciated that in an actual usage scenario, the sun asset 108 would be rendered on or via the display 106 relative to the perspective of the user 104. Once the user 104 has provided input defining the spatial event and the effect to be triggered in response to detection of the spatial event, the prototyping application can create an event-effect model for the modeled spatial interaction. The event-effect model defines the triggering relationships between the spatial event and the effect, and controls rendering of the virtual asset representative of the event effect via the display 106 in response to detection of the spatial event by the AR device using the prototyping application (and the AR-marker tracking mechanism or another spatial tracking mechanism). For example, once the event-effect model has been created, the prototyping application provides a testing mode wherein the user 104 can move the cup 112 relative to the lamp 110 and watch the sun asset 108 appear when the cup 112 is placed at the target position and disappear when the cup 112 is moved away from the target position.

The example usage scenario illustrated and described with reference to FIG. 1 provides merely one example usage scenario of the subject prototyping application. In various embodiments, the prototyping application can provide for creating a variety of different types of spatial events between objects based on relative positions of the objects, orientations of the objects, and movement patterns of the objects which may include any RW physical object or thing. For example, the prototyping application can facilitate prototyping interactions between one or more movable or mobile objects and one or more stationary objects capable of being spatially detected and tracked via the AR device, including buildings, natural structures, living creatures/beings (e.g., pets, animals, people, etc.) and so on. The prototyping application can also provide for creating spatial events based on relative positions, orientations and movement patterns of single objects in the RW environment. The prototyping application can also provide for creating various types of virtual assets to represent spatial effects and defining and controlling rendering positions of the virtual assets via the display 106 as well as behaviors, features and/or functions of the virtual assets. For example, in some embodiments, the prototyping application can allow the user to create dynamic virtual assets that change in appearance (e.g., flash, change color, change shape, change type), emit a sound, or provide some other type of dynamic response based on detection and/or non-detection of a particular user defined spatial event. For instance, in another example usage scenario applied to the cup and lamp example shown in FIG. 1, the prototyping application can allow the user to define a first spatial event corresponding to the cup 112 being moved to a first orientation relative to the lamp 116 and a second spatial event corresponding to the cup being moved to a second orientation relative to the lamp 110, and further create effects that includes changing the brightness of the lamp in association with rotation of the cup 112 from the first orientation to the second orientation as visualized via the sun asset changing brightness.

In this regard, in one or more embodiments, the prototyping application can employ a defined spatial interaction model that defines the types of spatial events and associated effects that may be prototyped for one or more objects. In accordance with the defined spatial interaction model, the input is a spatial event (e.g., spatial movement) of a real-world object and the output is a certain virtual effect that responds to the spatial event. In various embodiments, the design space of the spatial interaction model can be formulated by the following four dimensions:

Dimension 1: Quantity. Spatial interactions of smart objects can be classified according to device quantity, i.e., single-object or multiple-object interaction. The interaction of a single object utilizes the spatial pose or movement of the object itself. The interactions among multiple objects describe their spatial relationships and configurations of the respective objects.

Dimension 2: Proximity. Spatial interaction of one or more smart objects can further be classified according to proxemic dimensions of the one or more objects (e.g., measurements of position, orientation, distance, and movement).

Dimension 3: Movement Form. This dimension differentiates spatial interactions based on discrete movement, i.e., happening once during a period of time, and continuous movement, i.e., continuously changing during a period of time.

Dimension 4: Interaction Space. Spatial interactions of objects can vary across two dimensions (2D) or 3D dimensions. In 2D dimensions, objects move in a 2D plane, and thus it is a 3-DoF interaction. In 3D dimensions, objects move and/or rotate in the 3D space so it is a 6-DoF interaction. The movements can also be divided further into moving along an edge, on a plane/surface, and in mid-air.

In this regard, in some embodiments, the defined spatial interaction model can define the input spatial event as being a discrete event or a continuous event. The spatial interaction model can further define the output as being a discrete effect or a continuous effect. In this regard, a paired input event and an output effect can compose a discrete or continuous input-output interaction. Continuous input-out interactions can be further categorized into synchronous and tween interactions. The former means that the spatial status of the virtual effect is synchronously changed with the spatial status of the smart object, and the latter means that the spatial status of the virtual effect is continuously changed according to the starting and ending status of the object.

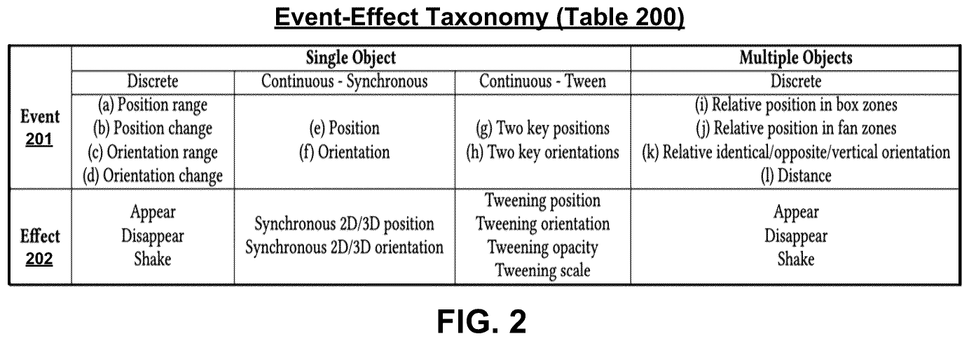

FIG. 2 presents a table (Table 200) defining a taxonomy of example input events 201 and corresponding example output effects 202 that may be defined by the spatial interaction model in accordance with one or more embodiments. In one or more example embodiments, each type of input event can trigger the corresponding type of output effect defined in Table 200. In accordance with Table 200, the spatial interaction model can define twelve different types of input events, respectively labeled (a)-(l). The different input event types can include single object events and multiple object events. Single object events refer to movement of a single object relative to a defined 2D or 3D plane or point in a 2D/3D space. The single object events are further categorized into discrete events (i.e., events (a)-(d)), continuous synchronous events (i.e., events (c) and (f) and continuous tween events (i.e., events (g) and (h)). For a single smart object, the spatial events (input) and the triggering effects (output) can be categorized from the dimensions of movement form and proximity with multiple variations, as summarized in Table 200. The multiple object events include discrete events (i)-(l). Multiple object events correspond to movement of two or more objects.

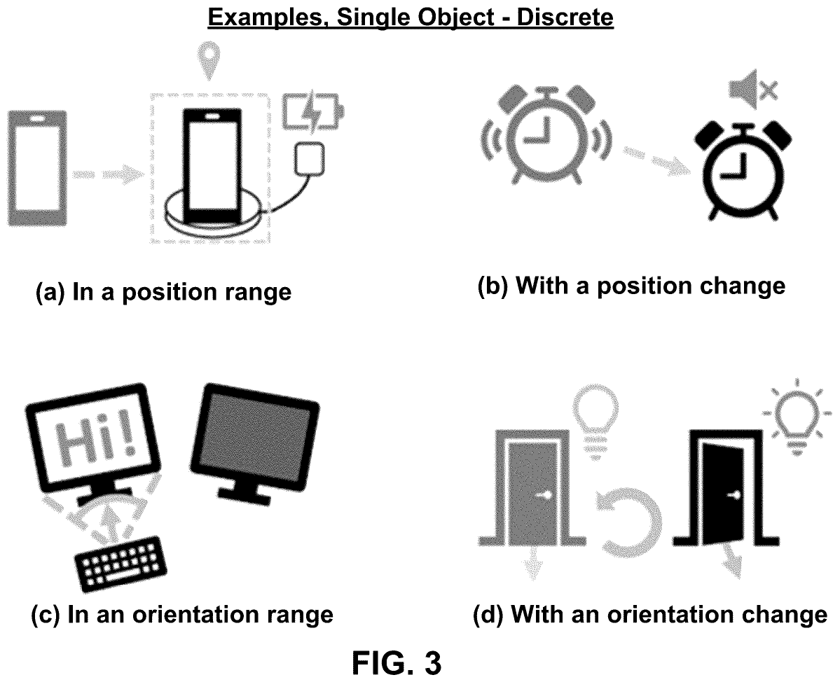

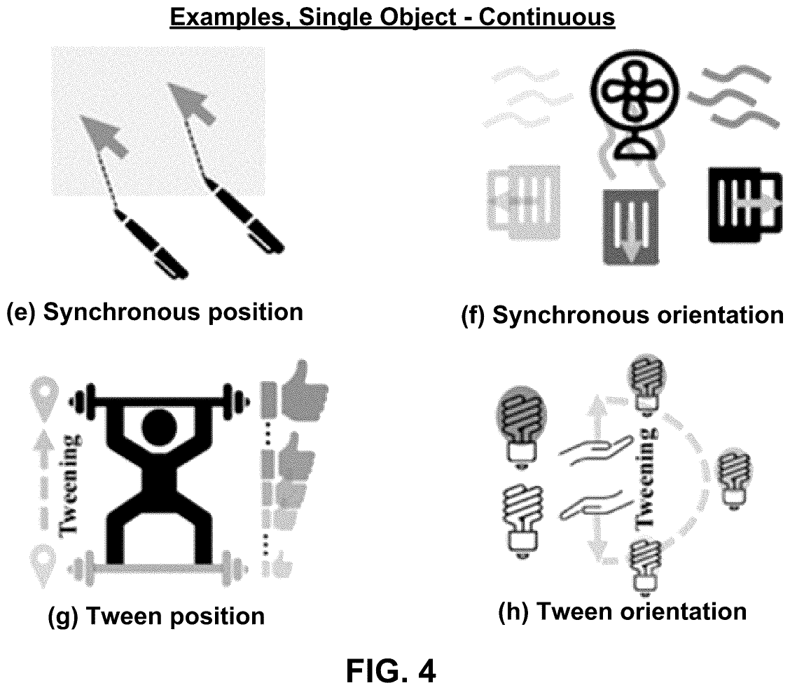

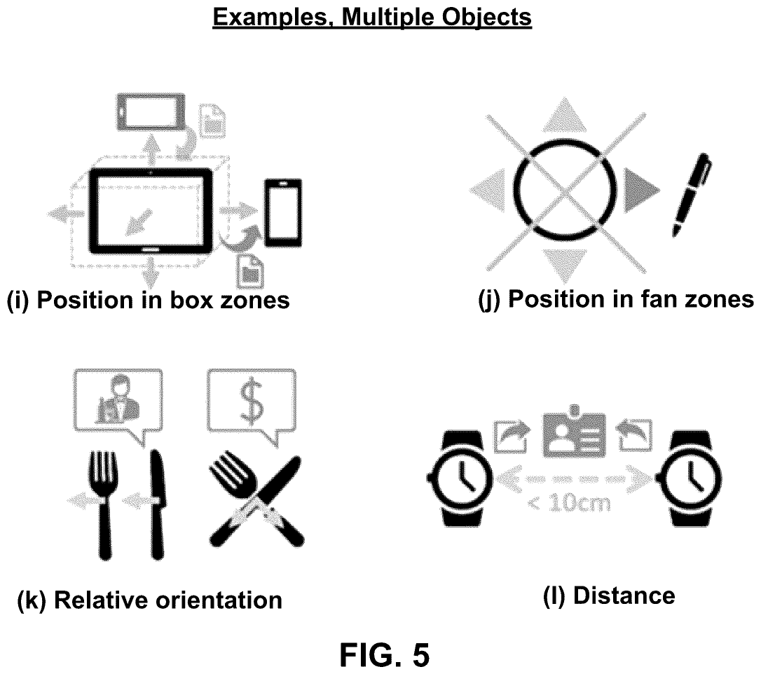

FIG. 3 illustrates examples of the single object discrete events (a)-(d) and the triggered effect of the spatial interaction model. FIG. 4 illustrates examples of the single object continuous events (c)-(h) and the triggered effect of the spatial interaction model. FIG. 5 illustrates examples of the multiple object discrete events (i)-(l) and the triggered effect of the spatial interaction model.

Single Object Discrete Interaction. With reference to FIGS. 2 and 3 and example input event types (a)-(d), single object discrete interactions can include position range, orientation range, position change, and orientation change. These discrete events can be mapped to discrete effects represented by AR content, like appear, disappear, and shake, which can simulate the real-world effects easily for prototyping. For example, single object discrete events can include moving a single object within (and away) a position range relative to another RW object and/or a defined 2D/3D space, as shown FIG. 3(a). In the example shown in FIG. 3(a) the single object is the cell phone, the spatial event corresponds to movement of the cell phone within (and away from) a position range of the charger, and the effect corresponds to charging of the cell phone, as represented by the appearance of the display of the battery symbol (e.g., an appear affect). Single object discrete events can also include moving a single object from a first position to a second position (i.e., with a position change), as shown in FIG. 3(b). In the example shown in FIG. 3(b) the single object is the alarm clock, the spatial event corresponds to movement of the clock to a different position relative to the position of the alarm clock depicted in gray (where the clock is indicated as sounding an alarm), and the effect is stopping of the alarm, as represented by the display of the “sound-off” symbol (e.g., an appear affect). Single object discrete events can also include bringing the object in an orientation range relative to a defined orientation (with range=0 meaning it faces a certain direction) as shown FIG. 3(c). In the example shown in FIG. 3(c) the object is the computer, the spatial event corresponds to orienting the computer within (and away from) a defined orientation range relative to an orientation of the keyboard, and the effect corresponds to turning the computer on (and off), as represented by the appearance of the “Hi!” symbol on the computer screen (i.e., an appear/disappear effect). Single object discrete events can also include changing the orientation of the single object, as shown in FIG. 3(d). In the example shown in FIG. 3(d), the object is the door, the spatial event corresponds to opening/closing the door (i.e., changing orientation from a closed state to an open state and vice versa), and the effect corresponds to turning a light on and off, as represented by the change of the lightbulb symbol from off state when the door is closed to the on state when the door is open.

Single Object Synchronous Interaction. With reference to FIGS. 2 and 4, single object synchronous effects are tightly related to synchronous events from the proximity measurement of position and orientation. For synchronous position or orientation events (FIGS. 4(e) and (f), the effect can include 2D/3D movement of virtual content as responding to the 3D movement of the object synchronously. For example, in the example shown in FIG. 4(e), the pen is the object, the spatial event corresponds to movement of the pen synchronously relative to a projector screen (or another defined 2D/3D plane) and the effect corresponds to projection of a laser beam pointer, as represented by the arrow symbols which can change synchronously with the spatial status of the pen (e.g., the direction of the arrows symbols can mirror or reflect the direction of the pen. In the example shown in FIG. 4(f), the single object being moved is the cup, the spatial event corresponds to orientating the cup at different orientations relative to the fan, and the effect is changing the orientation of the fan, as represented by the wind symbols which can change synchronously with the orientation of the cup relative to the fan.

Single Object Tween Interaction. Similar to animation keyframing, tween interaction describes a continuous interaction by specifying two key statuses (i.e., starting status and ending status) and interpolating the intermediate status according to the specified key statuses. For example, the two variant positions or orientations of the object can be set as the starting and ending event tweens. The two variant effects (e.g., positions, orientations, opacities, and scales) of the virtual contents can be set as starting and ending effect tweens. Each pair of event tweens can be mapped to each pair of effect tweens. For instance, in the example shown in FIG. 4(g), the object being moved is the bench press bar, the spatial event corresponds to movement of the bench press from the floor position to the final position above the user's head, and the effect includes providing an indication of lifting success which gradually increases as the user moves the bench press bar higher and higher to the final position, as represented by the “thumbs up” symbols which increase in size. In the example, shown in FIG. 4(h), the object being moved is the lightbulb and spatial event corresponds to rotating the lightbulb from a starting orientation to a final orientation (e.g., in association with screwing in the lightbulb). The effect corresponds to the brightness of the lightbulb changing from completely off to gradually increasing.

Multiple objects. With reference to FIGS. 2 and 5, since the spatially aware interactions happening among multiple objects are more complex, the example spatial events modeled for multiple objects in the spatial interaction model represented by the taxonomy shown in Table 200 are based on discrete interactions. However, it should be appreciated that multiple object interactions can include continuous events as well in various additional embodiments. As applied to discrete events, the spatial interaction model can classify the spatial events (input) and the triggering effects (output) from the dimension of relative proximity, as summarized in Table 200.

Relative position. Two or more objects can be manipulated by changing their relative positions. For example, in some embodiments, the 3D space around an object can be roughly divided into six zones: front, back, above, below, left, and right and other object(s) can be placed in one of the zones to trigger a discrete effect, as shown in FIG. 5 (i). In the example shown in FIG. 5 (i), box zones are defined relative to a tablet and positioning of the cell relative to the tablet in different box zones can trigger different effects, such as transferring data from the cell phone to the tablet when positioned in the top zone and transferring data from the tablet to the cell phone when positioned in the right zone. Similarly, the 2D space around an object can be roughly divided into four fan zones: left-front, left-back, right-front, and right-back as shown in FIG. 5(j). In this example, the circle corresponds to the surface of a table and the pen can be positioned in different phan zones to trigger different effects indicated by the tringle symbols changing in opacity when the pen is positioned in the corresponding fan zone.

Relative orientation. Multiple objects can also be manipulated by changing their relative orientations as illustrated in FIG. 5 (k). For example, an object can be in identical, opposite, and vertical directions from another object(s). In the example shown in FIG. 5 (k), the fork and the knife can be positioned in a first relative orientation to one another to trigger a first effect (e.g., calling the waiter (as indicated by the waiter icon appearing), and a second orientation relative to one another to trigger a second effect (e.g., paying the bill).

Distance. Multiple objects can be also placed in the 3D space greater than or less than a defined distance from one another to trigger different effects, as illustrated in FIG. 5 (l).

Combinations. Besides the interactions of multiple objects discussed above, a combination of multiple events of single objects can also be considered as the interactions among multiple objects. For example, when a chair is dragged from a desk, and a mouse on the table is moved with a position change, the computer will power off. Various other interaction paradigms are also envisioned.

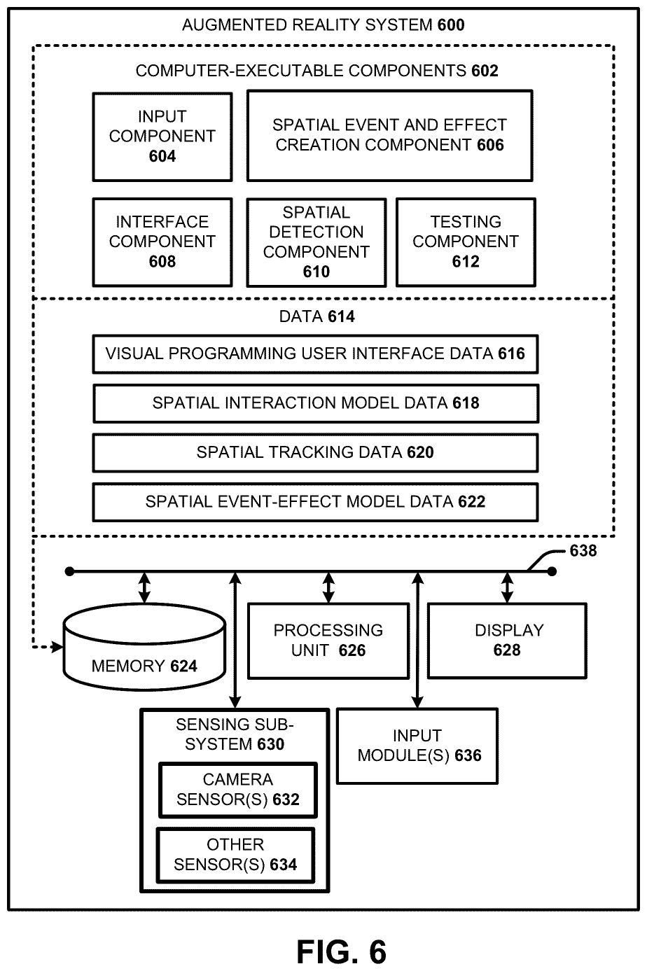

Turning next to FIG. 6, illustrated is an example AR system 600 that facilities prototyping applications of spatially aware smart objects in accordance with one or more embodiments described herein. One or more embodiments of the non-limiting system AR system 600 include one or more devices, systems and/or apparatuses that can enable a process to specify an event in an AR environment overlaying a RW environment and facilitate interaction between the two environments, in accordance with one or more embodiments described herein. Repetitive description of like elements and/or processes employed in respective embodiments is omitted for the sake of brevity. While referring here to one or more processes, facilitations, and/or uses of the non-limiting AR system 600, description provided herein, both above and below, also can be relevant to one or more non-limiting systems or elements of other non-limiting systems described herein, such as the non-limiting system 100.

Embodiments of systems described herein can include one or more machine-executable components embodied within one or more machines (e.g., embodied in one or more computer-readable storage media associated with one or more machines). Such components, when executed by the one or more machines (e.g., processors, computers, computing devices, virtual machines, etc.) can cause the one or more machines to perform the operations described.

For example, AR system 600 can include computer-executable components 602 (e.g., input component 604, spatial event and effect creation component 606, interface component 608, spatial detection component 610 and testing component 612) that can be stored in memory associated with the one or more machines. The memory can further be operatively coupled to at least one processing unit such that the components can be executed by the at least one processing unit to perform the operations described. For example, in some embodiments, these computer/machine executable components can be stored in memory 624 of the AR system 600 which can be coupled to processing unit 626 for execution thereof. Examples of said and memory 624 and processing unit 626 as well as other suitable computer or computing-based elements, can be found with reference to FIG. 16, and can be used in connection with implementing one or more of the systems or components shown and described in connection with FIG. 6 or other figures disclosed herein. The memory 624 can also include data 614 that can include visual-programming UI data 616 (e.g., which may define the features and functionalities of the visual programming UI), spatial interaction model data 618 (e.g., that may correspond to the spatial interaction model that defines and controls the types of spatial event and corresponding effects, as represented by the taxonomy illustrated in Table 200 or another taxonomy), spatial tracking data 620 (e.g., that may define and control a process for tracking and determining relative spatial positions of objects in a RW environment) and spatial event-effect model data 622 that corresponds to the user created and saved prototypes of spatial interactions between objects in accordance with the disclosed techniques.

The AR system 600 can further include (or be operatively coupled to) a display 628, a sensing sub-system 630, and one or more input modules 636. The display can include any suitable display capable of overlaying AR content in an RW environment (e.g., a graphical display, a holographic display, or another suitable AR display). The sensing sub-system 630 can include one or more camera sensors 632 (e.g., one or more cameras) and optionally one or more other sensors 634. The one or more other sensors 634 comprise motion detection sensors, infrared sensors, acoustic sensors, microphones, speakers, and/or the like. In various embodiments, the one or more camera sensors 632 and/or the one or more other sensors 634 can comprise or correspond to built-in sensors (e.g., physically coupled to the AR system 600). Any suitable number of camera sensors 632 and any suitable number of other sensors 634 can be employed by the AR system 600 to provide sensing information about the RW environment regarding the spatial information of objects present in the environment and other information about the RW environment (e.g., in association with facilitating gesture recognition input, object classifications, object size/shape, object properties, etc.).

The AR system 600 can further include one or more input suitable input modules 636 that facilitate receiving user input. In various embodiments, the input modules 636 can employ gesture recognition input technology and/or voice recognition input technology, however other suitable input devices are envisioned (and example of which are described with reference to FIGS. 8-12). The AR system 600 can further include a system bus 638 that couples the memory 626, the processing unit 626, the display 628, the sensing sub-system 630 and the one or more input modules 636 to one another.

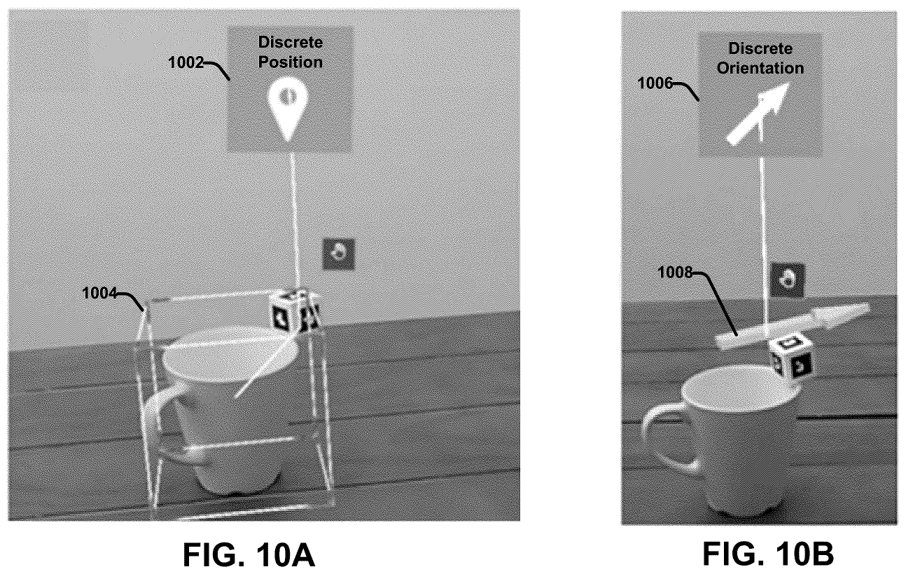

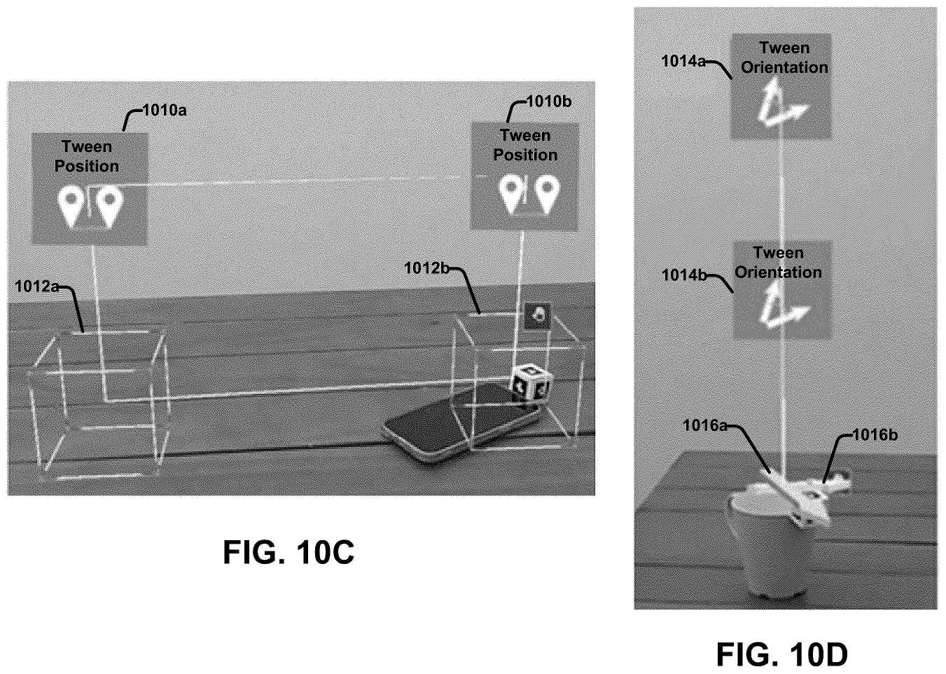

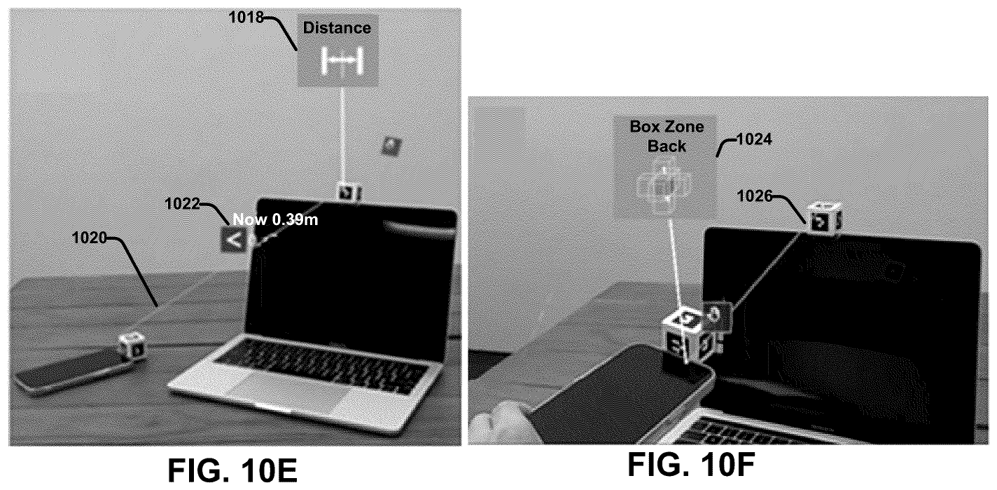

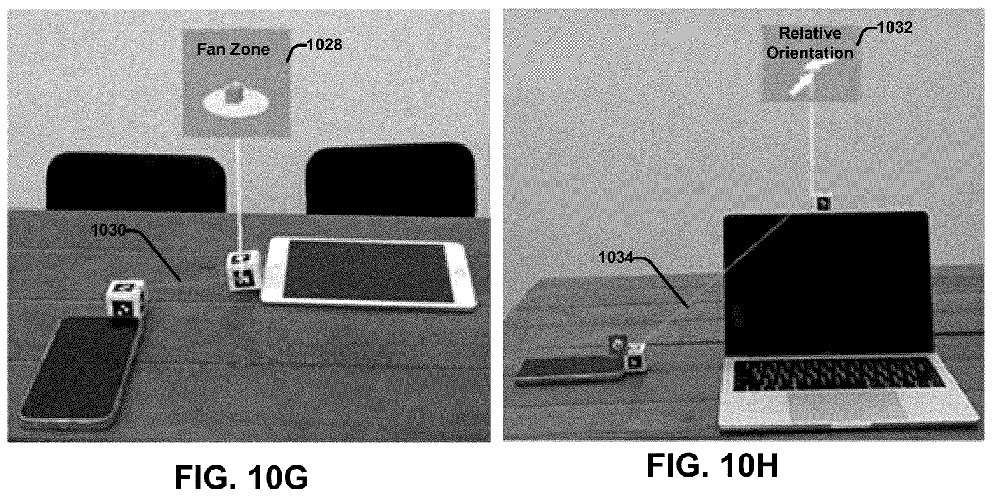

The architecture of AR system 600 can vary. With reference to FIGS. 1 and 6, in some embodiments, the AR system 600 can include or correspond to AR device 102. In some implementations of these embodiments, an entirety of the elements of the AR system 600 may be deployed on or within the AR device 102. In other implementations, one or more components of the AR system 600 may be deployed or associated with two or more communicatively coupled devices and/or systems (e.g., which may be communicatively coupled via one or more wired or wireless communication technologies). For example, in some embodiments, the AR system 600 and/or one or more components thereof can be associated with, such as accessible via, a cloud computing environment. For example, the AR system 600 can be associated with a cloud computing environment 1700 described below with reference to FIG. 10.

In various embodiments, the computer-executable component 602 and the data 614 can collectively correspond to an AR prototyping application that facilitates prototyping applications of spatially aware smart objects using an AR device 102 as generally described with reference to FIG. 1 and system 100. In one or more embodiments, the interface component 608 can provide a visual programming UI configured for rendering via the display 628 (which may correspond to display 106) via which a user can access and control one or more features and functionalities of the AR prototyping application and/or the AR system 600. For example, the visual programming UI can include interactive virtual elements that can be interacted with by the user using gesture recognition input technology, voice recognition input technology or another suitable input technology (e.g., provided by the one or more input modules 636). The input component 604 can interpret commands received in association with user interaction with the virtual elements (or otherwise) and map the input commands to corresponding actions and events as defined by the visual programming UI data 616. In this regard, the visual programming UI data 616 can define and control the features and functionalities of the visual programming UI. In various embodiments, the interface component 608 can render the visual programming UI via the display 628 in association with moving/positioning one or more objects in the RW environment while viewing the objects/environment through the display (in association with prototyping events and effects based on moving/positioning of the one or more objects. Examples of the visual programming UI in accordance with one or more embodiments are illustrated in FIGS. 8-12 and described in greater detail infra.

In various embodiments, the functionality of the AR prototyping application controlled via the visual programming UI can include three main computer-executable or machine executable functions, respectively corresponding to spatial-detection component 610, a spatial event and effect creation component 606, and a testing component 612.

In one or more embodiments, the spatial detection component 610 can determine and track spatial poses of one or more objects in association with moving the one or more objects within an RW environment. For example, the spatial detection component 610 can determine and track the spatial poses (e.g., 2D position, 3D position, 2D orientation, 3D orientation, etc.) of a smart object (or an object corresponding to a smart object). In association with determining and tracking the relative spatial positions of objects, the spatial detection component 610 can also determine and track movement or motion patterns of a moving object, such as direction, speed of the object in real-time.

In various embodiments, the RW environment can include or correspond to the environment within the FOV of the display (e.g., display) of the AR system 600, however other configurations are envisioned. For example, in some embodiments, the spatial detection component 610 can determine and track the relative spatial positions of objects present in the RW environment that are outside the FOV of the display. In some embodiments, the spatial detection component 608 can determine and track the relative spatial positions of the objects using AR-marker technology, wherein one or more AR markers are positioned on or near the respective objects being manipulated, however other object position tracking mechanisms are envisioned (e.g., markerless deep-learning-based approaches).

The spatial event and effect creation component 606 provides a creation mode of the visual programming UI which allows users to create and define spatial events corresponding to spatial interactions between the objects based on relative positions and/or movement patterns of one or more objects. For instance, one example of a spatial event can include placement of a first object within a defined distance relative to a second object. Another example of a spatial event can include positioning of a first object at a specific orientation relative to a second object. Another example of a spatial event can include movement of a first object relative to a second object along a defined trajectory path. Other examples of spatial events can include the examples described with reference to FIGS. 2-5.

In some embodiments, the spatial event and effect creation component can define and control the types of spatial events that can be modeled (e.g., as defined the spatial interaction model data 618). For example, in some embodiments, the spatial events can include a predefined set of twelve different types of spatial events (e.g., corresponding to the taxonomy presented in Table 200 or another taxonomy). In other embodiments, the number and type of spatial events that can be modeled using the application can vary and be user defined.

In various embodiments, the spatial event and effect creation component 606 generates spatial event information defining a spatial event corresponding to a defined spatial position or movement of one or more objects in a RW environment, wherein the spatial event information is generated based on first user input received via the visual programming UI. For example, the defined spatial position may be based on one more relative spatial positions (which includes orientation) of a first object to a second object in 2D or 3D and/or or a movement pattern of the first relative to one or more second objects. In other embodiments, the spatial event can correspond to a movement pattern or orientation of an object relative to the earth. For example, the spatial event can correspond to one or more of the spatial events 201 described with reference to FIGS. 2-5.

In various embodiments, the spatial event is defined based on the 6-DoF poses being tracked by the spatial detection component 610 in association with moving the one or more objects in the RW environment. With these embodiments, the first user input can indicate the one or more target relative positions (e.g., a relative distance and/or a relative orientation). For example, in some embodiments, the first user input can indicate the one or more target relative spatial positions based on placement of the one or more objects at the target relative spatial position within the FOV of the display in association with moving/positioning the objects in the creation mode. For example, in association with moving the one or more objects relative to one another, the user can position the one or more objects at a target relative spatial position that corresponds to a position of the objects where the user would like one or more of the objects to perform a desired output function (e.g., moving to cup to a specific position relative to a lamp to cause the lamp to turn on). In this regard, the positioning of the objects at the target relative spatial position corresponds to one example of a spatial interaction corresponding to a spatial event. Via the visual programming UI, the user can provide input setting the one or more target relative positions of the objects as a spatial event.

In some embodiments, the interface component 608 can render a virtual asset (e.g., a visual icon, symbol, etc.) via the AR device display in association with reception of the user input setting the spatial event that provides a visual indication of the spatial event in association with setting/configuring the spatial event. For example, the virtual asset may include correspond to a bounding box or another visual indicator that indicates one or more target relative spatial positions.

The spatial event and effect creation component 606 can further provide for creating and defining an effect of the spatial event by receiving additional user input via the visual programming UI. The spatial event and effect creation component 606 further generates event effect information defining the effect of the spatial event based on the additional user input received via the visual programming user UI and generates an event-effect model for the spatial interaction based on the spatial event information and the event effect information. Event-effect models created by the spatial event effect and creation component 606 are represented in system 600 by spatial event-effect model data 622.

In various embodiments, the effect can include rendering of a visual virtual asset (i.e., a virtual object) via the display of the AR device (e.g., display 628 of system 600 and/or display 106. Additionally, or alternatively, the effect can include rendering of a sound, a haptic response, or another type of output signal or effect via the AR device or another device communicatively coupled to the AR device. In some embodiments, the spatial event and creation component 606 and the visual programming UI can provide for defining and controlling the type, appearance, display position and/or a behavior of the virtual asset in response to detection of an occurrence of the spatial event (e.g., by the spatial detection component 610). For example, in some embodiments, the virtual programming UI can allow the user to select a desired virtual asset from a set of preconfigured virtual assets with one or more preconfigured functionalities or features (e.g., a virtual object corresponding to a sun that can be configured to change color or brightness in response to detection of user defined spatial event). Additionally, or alternatively, the virtual programming user interface can provide one or more AR object design functions via which the user can draw and create their own virtual asset, import a previously generated virtual asset from another system, and so on.

In some embodiments, the interface component 608 can render the virtual asset selected/created for the event effect (e.g., a visual icon, symbol, etc.) via the AR device display in association with reception of the additional user input setting/creating the spatial event effect that provides a visual indication that the spatial event effect in association with creating/configuring the event effect. In some embodiments, the visual programming UI can further provide a mapping tool via which the user can draw a line connecting the rendered virtual assets corresponding to the spatial event and the event effect to provide input indicating and setting the connection between spatial event and the event effect. With these embodiments, the spatial event and effect creation component 606 can map the spatial event information to the even effect information within the event-effect model based on reception of such user input.

The testing component 612 can provide and execute a testing mode of the visual programming UI using the AR device, wherein the testing mode facilitates testing the spatial event (e.g., corresponding to a single object spatial event or a multiple object spatial event) in accordance with the event-effect model created for the spatial event using the event-effect creation component creation workflow described above. In testing mode, the user can again freely move and position the objects relative to one another within the FOV of the display of the AR device and the spatial detection component 610 determines and tracks new relative spatial positions of the one or more objects in association with movement of the one or more objects in the testing mode. The interface component 608 can further render the virtual asset via the AR display in accordance with the event-effect model in response to the detection of the spatial event by the spatial detection component 610 (e.g., based on a new relative special position of the new relative positions corresponding to the one or more target relative positions, based on the movement pattern of the object corresponding to a target movement pattern, etc.). In this regard, the testing mode allows user to perform the defined spatial object events by manipulating the real-world objects and trigger the corresponding effects (e.g., rendering of a virtual asset representative of the effects) and watch and refine the events and the effects in a user-friendly manner without advanced programming skills via the visual programming user interface.

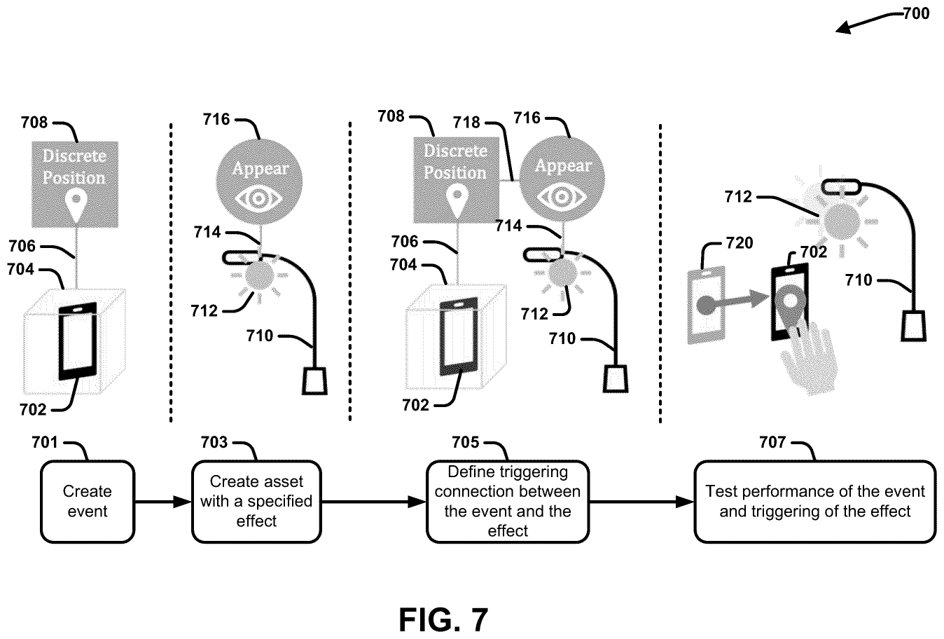

FIG. 7 presents a diagram of an example workflow 700 for creating and testing an event-effect model for a spatial interaction between objects using the AR system 600 (or other systems described herein. Workflow 700 is illustrated in association with creating a discrete single object event based on movement of a mobile phone 702 within a position range of a lamp 710. FIG. 700 illustrates some elements of virtual content that may be rendered to the user via the visual programming UI (e.g., by interface component 608) in association with creating and testing the event-effect model for the spatial interaction.

With reference to FIG. 7 in view of FIG. 6, in accordance with workflow 700, at 701, the user creates an event (e.g., discrete position in this example) visualized by a square proxy 708 above a real-world object (e.g., the mobile phone 702). In association with creating the event at 701, the user can position the mobile phone 702 at a desired target position relative to the lamp 710 and provide input via the visual programming UI setting the target position as corresponding to spatial event. The spatial detection component 610 can detect the relative position of the mobile phone 702 to the lamp 710 at the target position and the interface component 608 can create a virtual bounding box 704 around the mobile phone in 3D that defines the 3D position of the mobile phone 702. The interface component 608 can also generate a line 706 connecting the bounding box 704 to the square proxy 708.

In one or more embodiments, the spatial detection component 610 can employ the following methods for scene understanding. For the static, fixed, and large planes, spatial detection component 610 can automatically detect object planes. Additionally, or alternatively, the visual programming UI can enable users to manually create a plane and move and rotate it to a desired pose. This plane can be specified as the interaction space of virtual contents. For moving objects, the spatial detection component 610 can utilize an AR-marker-based tracking method (or another spatial detection method) to determine and the 6-DoF pose of an object being tracked real-time.

At 703, the user creates an asset 712 (e.g., a sun symbol) with a specified effect (e.g., appear) represented by a circular proxy 716 above the asset 712. In this regard, in association with creating the asset 712, the visual programming UI can provide tools that allow the user to select and define the asset and the effect. The interface component 608 can also render the asset 712 and the circular proxy 716 and a connection line 714 connecting the circular proxy 716 to the asset 712.

At 705, the user defines the triggering connection between the event and the effect by drawing a line 718 connecting the event proxy 708 and the effect proxy (e.g., using the tools provided by the visual programming UI). Based on performance of steps 701, 703 and 705, the event and effect creation component generates an event-effect mapping for the spatial interaction.

At 707, the user tests the event-effect model by manipulating the object to perform the specified event and thus trigger the effect in testing mode. In this regard, the user can move the mobile phone from a first position 720 to the target position to cause the sun asset to appear (or disappear in association with moving the mobile phone away from the target position.

In this regard, as exemplified by workflow 700, the AR prototyping application can enable users to follow an input-out triggering workflow to define the input events, output effects, and their relationships from a visual programming UI for various usage scenarios, and test the results through real-world object manipulation in situ. In some embodiments, the input-output triggering workflow can be based on the spatial interaction model represented by the taxonomy illustrated in Table 200. With these embodiments, the visual programming UI can enable users to prototype a spatial interaction by specifying an input spatial event and the corresponding output virtual content, and creating the triggering connection between the input and the output. For a single object, any discrete input can be mapped to any discrete output, which leads to 12 (=4×3) types of interactions. Any synchronous input can also be paired with any synchronous output except two less meaningful/useful pairs (i.e., synchronous 3D position with synchronous 3D orientation, and synchronous 3D orientation with synchronous 3D position), thus leading to 6 types of synchronous interactions. Any tween input can be paired with any tween output, resulting in 8 (=4×2) types of tween interactions. For multiple objects, the six types of input can be mapped to any discrete input, so it has 18 (=6×3) types of interactions. In some embodiments, the viAR prototyping application also provide users with the logical operators (i.e., and, or, not operators) to help specify and combine the multiple interactions.

FIGS. 8-12 present an example visual programming UI in accordance with one or more embodiments. The visual programming UI presented in FIGS. 8-11 utilizes the spatial interaction model represented by the taxonomy illustrated in Table 200, however it should be appreciated that the visual programming UI can be adapted to account for other types of spatial events and interactions. The visual programming UI illustrated in FIGS. 8-11 corresponds to a holographic UI wherein the graphical UI elements correspond to holograms projected onto the RW environment (e.g., environment 802) capable of being interacted with via gesture input.

Additional details of the input-output triggering workflow and the visual programming UI are now described with reference to FIGS. 8-12.

FIG. 8 illustrates a hand menu 800 of the visual programming UI that corresponds to a general menu that can be presented via the display (e.g., display 106) of an AR device (e.g., AR device 102) via the interface component 608 when the user's palm 804 is positioned up (e.g., as shown in FIG. 8) in association with utilization of the disclosed AR prototyping application. The hand menu 800 contains an event button 810, an effect button 808, a mapping button 812, and several mode switching buttons (e.g., hide/show all button 814, author/test button 816, global/focus button 818) and a create plane button 820. In association with creating an event-effect model for a spatial interaction between objects, the user can start with the creation of either input events or output effects. However, to follow the example input-output workflow described above with reference to FIG. 7, the visual programming UI is described in association with creating the input events first.

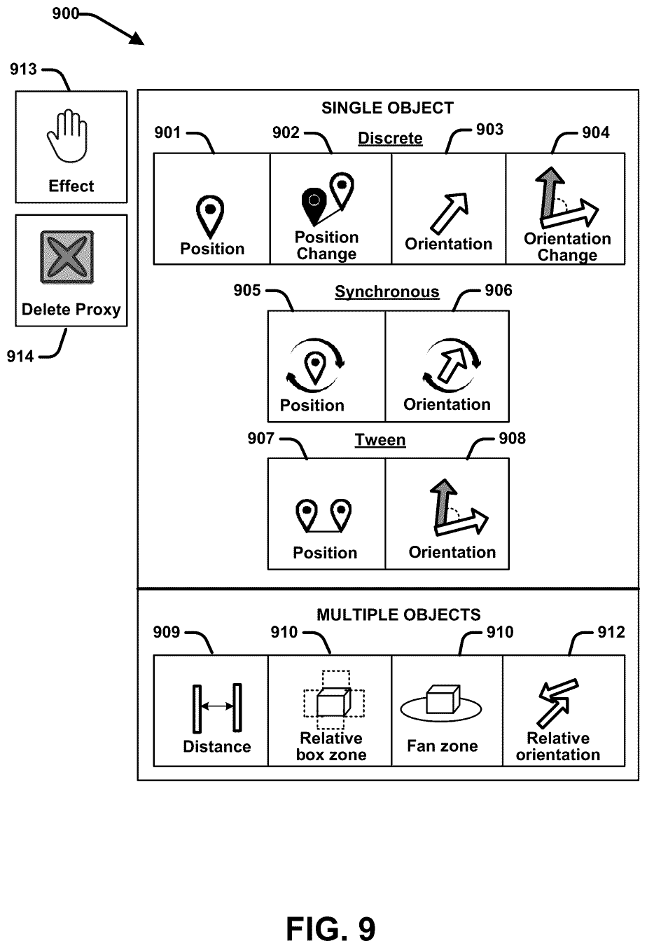

In this regard, in one or more embodiments, the user can begin creating an input event by using gesture commands to move the hand menu about the RW environment 802 and align the event button 810 near an object (not shown) located in the FOV of the display to be moved/manipulated. The user can then press/select the event button 812 which can cause the event button to become active and render the event menu 900 illustrated in FIG. 9 (e.g., which is displayed near the object). Then the user can create the input events from the event menu 900. In the example embodiment shown in FIG. 9, the event menu 900 includes 12 buttons 901-912 for the 12 different event types defined in Table 200 (e.g., including buttons 901-904 for the 4 types of single object (SO) discrete events (i.e., discrete position, discrete position change, discrete orientation, and discrete orientation change); buttons 905 and 906 for the 2 types of SO synchronous events (i.e., synchronous position, synchronous orientation); buttons 907 and 908 for the two types of SO tween events (i.e., tween position, and tween orientation); and buttons 909-912 for the 4 types of multiple object events (i.e., distance, relative box zone, relative fan zone, and relative orientation) for multiple objects. The event menu 900 also includes a mode switching button 913 to return to the hand menu 800 and a button 914 to delete a created proxy for a spatial event. Once the user successfully creates an event using the visual programing UI, the interface component 608 renders a square proxy (e.g., proxy 708) near the object with a connected line (e.g., line 706), as shown in step 701 in FIG. 7. The steps for creating the different types of the spatial events using the visual programming UI are further elaborated below with reference to FIGS. 10A-10H and FIG. 9.

FIGS. 10A-10H present example features of the visual programing UI in association with creation of different types of spatial events corresponding to the event buttons of the event menu 900 (e.g., single object events are demonstrated in FIGS. 10A-10D and multiple object events are demonstrated in (FIGS. 10E-10H).

FIG. 10A demonstrates creation of a single object (SO) discrete position event. In association with creating a SO discrete position event (and/or a SO position range event), the user can move the object of interest (e.g., a cup in this example) to a desired target location where the user wants the cup to trigger an effect and then press the position button 901. The interface component 901 further generates and renders a bounding box 104 around the object and a square event proxy 1002 connecting with the object through a line to represent the created event. In some embodiments, the visual programming UI can enable the user to adjust the size of the bounding box 1004 using a pinch gesture to change the position range associated with the triggering event.

FIG. 10B illustrates creation of a SO discrete orientation event (e.g., a discrete orientation and/or orientation range). In association with creation of this type of event, the user can manipulate the object of interest (e.g., a cup in this example) to face a target orientation and then press the orientation button 903. The interface component 608 then renders an arrow symbol 1008 on or near the center of the object and facing direction the same as the target orientation. The interface component 608 renders a square event proxy 1006 connecting with the object through a line to represent the created event. The visual programming UI can also enable the user to specify an orientation range by rotating the object in another direction and press the orientation button 903 again to create another arrow. The orientation range will be defined based on the smaller angle between the two arrows.

Position change and orientation change events can respectively be created by pressing the position change button 902 and orientation change button 904 in association with setting the object at a target position or orientation. In association with creating these types of events, the interface component 608 renders a corresponding event proxy (e.g., similar to proxy 1002 and 1006) above the object to visualize setting of the event. These types of events can trigger a desired effect when the position of the object changes from the set target position or orientation.

Synchronous 3D position/orientation events can respectively similarly be created by pressing button 905 and button 906 respectively and moving the object of interest synchronously to different positions and/or different orientations. These types of events use the 3D position or 3D orientation of the object as a trigger to drive the spatial movement of the virtual content representing the effect in a synchronous manner.

FIG. 10C demonstrates creation of a SO tween position event and FIG. 10D demonstrates creation of a SO tween orientation event. The visual programming UI can enable the user to create position and orientation tween events by specifying the starting and ending spatial positions/orientations of the object of interest. For example, in association with creating a tween position event, the user can move the object of interest (e.g., a phone in this example) to a starting position and press the tween position button 907. The interface component 608 then renders a first bounding box 1012a at the starting position and a first square event proxy 1010a connected to the bounding box to indicate setting the starting position. Then the user repeats this operation in association with moving the object to an ending position, which results in rending of a second bounding box 1012b at the ending position, a second square event proxy 1010b connected to the second bounding box 1012b and a line connecting the first and second event proxies to indicate setting the tween event. The tween position event can control triggering of virtual content representing the effect when the object is placed at the starting position, the ending position and/or in any intermediate position between the starting position and the ending position. For example, in association with setting an effect for a tween position event, the visual programming UI can enable the user to configure a virtual asset to change in appearance when the object is moved from the starting position to the ending position.

Tween orientation events (FIG. 10D) can be created in a similar manner. For example, in association with creating a tween orientation event, the user can position the object of interest (e.g., a cup in this example) to a starting orientation and press the tween orientation 908. The interface component 608 then renders a first arrow 1016a over the object indicating the starting orientation and a first square event proxy 1014a connected to the first arrow to indicate setting the starting orientation. Then the user repeats this operation in association with moving the object to an ending orientation, which results in rending of a second arrow 1016b over the object indicating the ending orientation, a second square event proxy 1014b connected to the second arrow, and a line connecting the first and second event proxies to indicate setting the tween event. The tween orientation events can control triggering of virtual content representing the effect when the object is placed at the starting orientation, the ending orientation and/or in any intermediate orientation between the starting orientation and the ending orientation. For example, in association with setting an effect for a tween position orientation, the visual programming UI can enable the user to configure a virtual asset to change in appearance when the object is rotated from the starting orientation to the ending orientation.

FIG. 10E demonstrates creation of a multiple object (MO) distance event. The visual programming UI can enable a user to create a distance event between two objects (e.g., a phone and a laptop in this example) by moving the respective objects to a desired separation distance and pressing the distance button 909. This results in rendering a square event proxy 1018 for the distance event. The visual programming UI can enable the user to use a pinch gesture (or another input mechanism) to draw and create a line 1020 from a triggering object (e.g., the phone) to a target object (e.g., the laptop) to set the distance event. The interface component 608 can also render the current distance value (e.g., “now 0.39 meters (m)) determined by the spatial detection 610) on the line 1020 and a button 1022 for changing/setting the distance value. A distance event can control rending a virtual asset selected for the effect based on the respective objects being positioned at or within the separation distance.

FIG. 10F demonstrates creation of a MO relative box zone event. A box zone event corresponds to creating a spatial event between two objects (a phone and a laptop in this example) based on a relative 3D position of the respective objects. FIG. 10G demonstrates creation of a MO relative fan zone event. A fan zone event corresponds to creating a spatial event between two objects (a phone and a tablet in this example) based on a relative 2D position of the respective objects. The visual programming UI can enable a user to create a box zone event by moving a subject object to one of the six box zones (i.e., front, back, above, below, left, and right) around a target object, pressing the relative box zone event button 910 (which results in rending the corresponding event poxy 1024) and drawing a connection a line 1026 between the two objects to complete setting the event. The visual programming UI can similarly enable a user to create a fan zone event (FIG. 10G) by moving a subject object to one the four fan zones (i.e., left front, left-back, right-front, and right-back) around a target object when the two objects are on the same plane, pressing the relative box zone event button 911 (which results in rending the corresponding event poxy 1028) and drawing a connection a line 1030 between the two objects to complete setting the event.

FIG. 10H demonstrates creation of a MO relative orientation event. A relative orientation event can be defined by placing two objects (a phone and a laptop in this example) in an identical, opposite, or vertical direction, pressing the relative orientation button 912 (which results in rending the corresponding event poxy 1032) and drawing a connection a line 1034 between the two objects to complete setting the event.

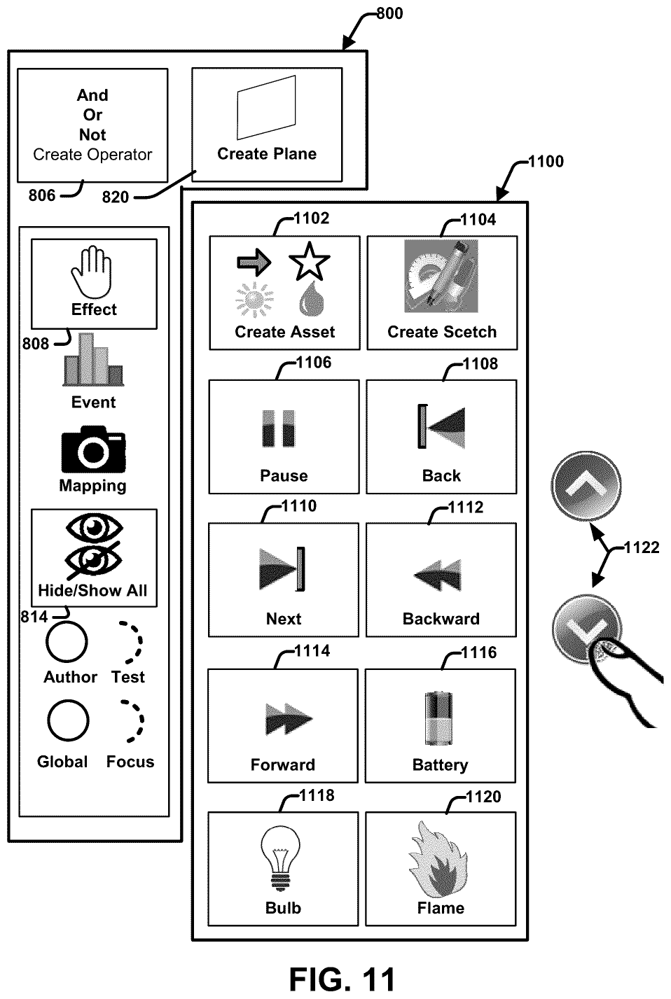

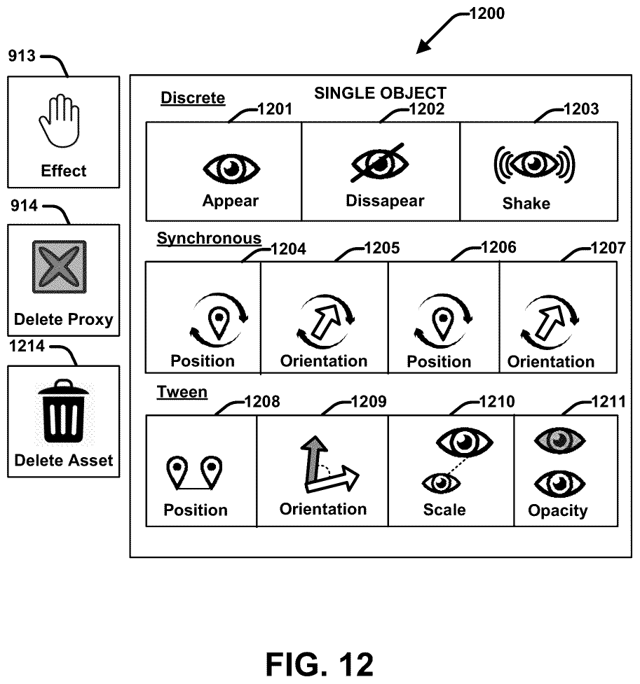

After creating the input event, the user can create the corresponding output effect (e.g., in accordance with step 703 and process 700) using the asset menu 1100 shown in FIG. 11 and the effect menu 1200 shown in FIG. 12. In one or more embodiments, the interface component 608 can render the asset menu 1100 in response to selecting the hide/show all button 814 from the hand menu 800. The asset menu 1100 includes a create asset button 1102 that can be selected to view and access an asset repository comprising a plurality of preconfigured virtual assets (assets 1106-1120) that may be used to represent effects. The asset menu 1100 can include a scrolling button 1122 via which the user can scroll through the repositor of pre-built assets. The asset menu 1100 also include a sketching button 1104 that provide tools for creating freehand sketches of virtual assets in association with selection thereof.

Associated with a selected asset, the effect menu 1200 (which may be rendered in response to selection of the effect button 808 from the hand menu 800) provides users with 11 types of preconfigured virtual effects (respectively corresponding to effect buttons 1201-1211) that can be used to set and control the behavior of the virtual asset representing the affect. A delete asset button 1214 is also provided. In this regard, the asset menu 1100 and the effect menu 1200 enable designers to create virtual assets by dragging the pre-built assets from the menu 1100 or drawing sketches (e.g., using a fingertip and gesture input or another input mechanism). Both visual and sound assets are supported, and they are represented by a 2D icon, a 3D model, or a free-hand sketch in the repository. In some embodiments, once the asset is added to the scene, the visual programming UI can enable a user can move it, rotate it, and change its scale using a pinch gesture. The user can also attach the asset to an automatically detected plane or surface (e.g., as detected by the spatial detection component 610) using ray casting. Additionally, or alternatively, the visual programming UI can enable the user to interactively create a plane, place it in a certain location and with a certain orientation, and specify it as the active moving area of the virtual asset (e.g., in association with selection of the create plane button 820). Then the designer can specify the animation effect to the created asset, visualized by a circular proxy (e.g., circular proxy 717) with the connected line (e.g., line 714) as shown in FIG. 7. In association with creating an effect, the visual programming UI can enable the user to control the rendered position and/or behavior of the virtual asset.

In accordance with the embodiment shown in FIG. 12, the visual programming UI supports 12 types of preconfigured effects respectively corresponding to effect buttons 1201-1211. It should be appreciated however that these effects are merely exemplary and that other types of effects are envisioned.

The “appear.” “disappear.” and “shake” effects (respectively corresponding to effect buttons 1201-1203) are discrete effects that can be added to the asset, visualized by a circular proxy. For the sound asset, the “sound playing” effect is associated with the “appear” and “shake” effects, and the “stop playing” is linked with the “disappear” effect.

The synchronous position/orientation effects (corresponding to effect buttons 1204 and 1204) can make the 2D/3D position/orientation of the virtual asset synchronously changed with the object. In some embodiments, to create a synchronous 2D position/orientation event, the designer must select an asset that is already attached to a spatial plane.

The tween position/orientation/scale/opacity effects (corresponding to effect buttons 1208-1211) can be used to add tween effects by specifying the starting and ending spatial states (i.e., effect tweens) of the assets. For the tween position effect, the user can move the asset to two separate positions. For the tween orientation effect, the user can rotate the asset to face two separate directions. For the tween scale effect, once the user presses the scale button for the first time, a bounding box will be shown at the asset. Then the user can specify two separate asset scales by adjusting the size of the bounding box using a pinch gesture. For the tween opacity effect an opacity slider can be displayed below the asset when the user presses the opacity button. Then the user can specify two asset opacity values by adjusting the slider.

To complete an input-output workflow, the visual programming UI can enable the user to create the triggering mapping between the input event and the output effect in accordance with step 705 of process 700. In this regard, with reference again to FIG. 7, the input event and the output effect are visualized with the corresponding event and effect proxies in the AR scene (e.g., event proxy 708 and effect proxy 716). In one or more embodiments, the visual programming UI can enable the user to use a pinch gesture (or another suitable input mechanism) to drag a line (e.g., line 718) from the event proxy to the effect proxy for discrete and synchronous events and effects, and drag two lines to connect the corresponding event and effect proxies for tween events.

The prototyping application also provides for creating compound events using logic operators in association selection of the logic operator button 806. For example, the logic operators can include three logic operators (i.e., and, or, not operators) for quickly creating logical events. The visual programming UI can enable users to dd these operators (represented by a corresponding virtual proxy rendered in the AR scene). In association with creating the triggering mapping between compound events and their effects, the user connects the event proxy first to the logic operator(s) proxy and then to the target effect proxy.

In the creation/authoring mode, the visual programming UI also provides a focus mode that allows users to select to display the related representations of one or multiple interested object(s) while hiding all the lines. When the user pinches an object, the lines related to it will appear and when pinching it again the lines will be hidden.

After the user authors all the input events, output effects, and their triggering relationships, the user can enter the testing mode in association with selection of the test button from the hand menu 800. When the user manipulates an object to perform the specified spatial interaction, the connected effect will be triggered. In some embodiments, the connection lines between the event proxies, operators, and effect proxies will turn green to indicate the event is successfully triggered, otherwise the lines stay in red. All of the proxies and lines will be hidden when the user presses the “Hide All” button. To avoid the user missing the triggered animation effect, the visual programming UI can render a replay button near the asset for replaying the effect. The user can watch and test the results multiple times and from any view.

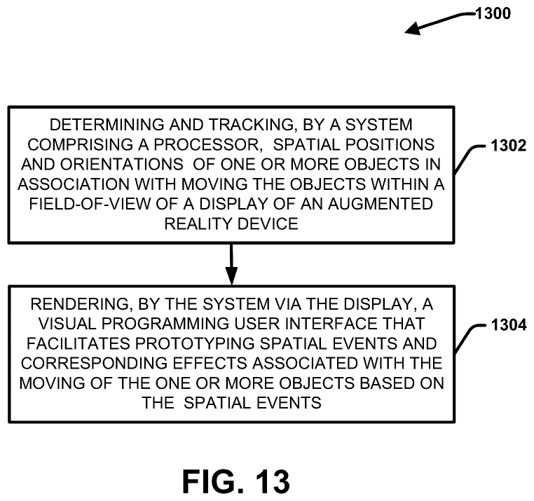

FIG. 13 presents a block diagram of another example, non-liming, computer-implemented method 1300 that facilitates prototyping applications of spatially aware smart objects in accordance with one or more embodiments. Method 1300 comprises, at 1302, determining and tracking (e.g., via spatial detection component 610), by a system comprising a processor (e.g., system 100, system 600 and the like) spatial positions and orientations of one or more objects in association with moving the objects within a FOV view of a display of an AR reality device (e.g., AR device 102 or the like). Method 1300 further comprises, at 1304 rendering, by the system via the display (e.g., display 106, display 628, or the like), a visual programming UI that facilitates prototyping spatial events and corresponding effects associated with the moving of the one or more objects based on the spatial events.

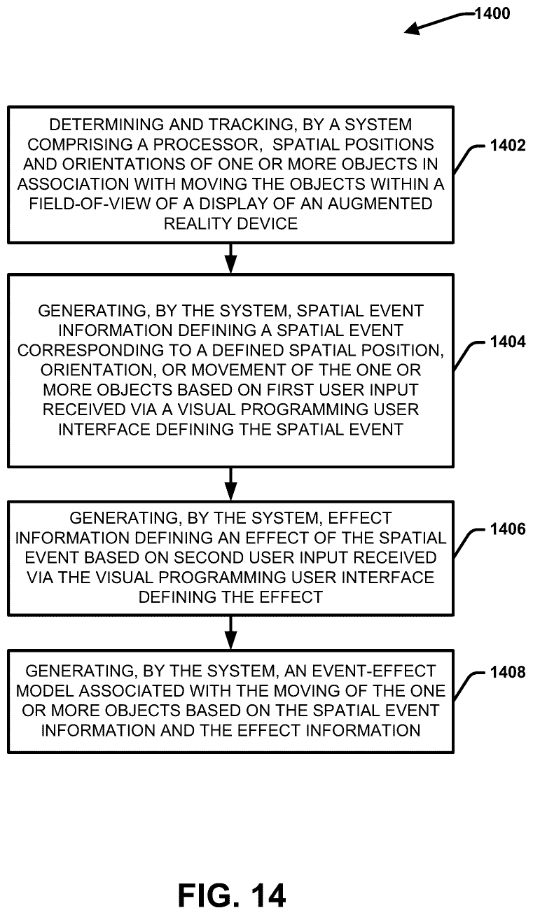

FIG. 14 presents a block diagram of another example, non-liming, computer-implemented method 1400 that facilitates prototyping applications of spatially aware smart objects in accordance with one or more embodiments. Method 1400 comprises, at 1402, determining and tracking (e.g., via spatial detection component 610), by a system comprising a processor (e.g., system 100, system 600 and the like) spatial positions and orientations of one or more objects in association with moving the objects within a FOV view of a display of an AR reality device (e.g., AR device 102 or the like). Method 1400 further comprises, at 1404, generating, by the system (e.g., via spatial event and effect creation component 606) spatial event information defining a spatial event corresponding to a defined spatial position, orientation or movement of the one or more objects based on first user input received via a visual programming UI defining the spatial event. Method 1400 further comprises, at 1406, generating, by the system (e.g., via spatial event and effect creation component 606), effect information defining an effect of the spatial event based on second user input received via the visual programming UI defining the effect. Method 1400 further comprises, at 1408, generating, by the system (e.g., via spatial event and effect creation component 606), an event-effect model associated with the moving of the one or more object based on the spatial event and effect information. In this regard, the event and effect model define the spatial event, the triggering condition and the effect and controls rendering of the virtual asset (e.g., a visual and/or audible asset) representative of the effect based on detection of the triggering condition.

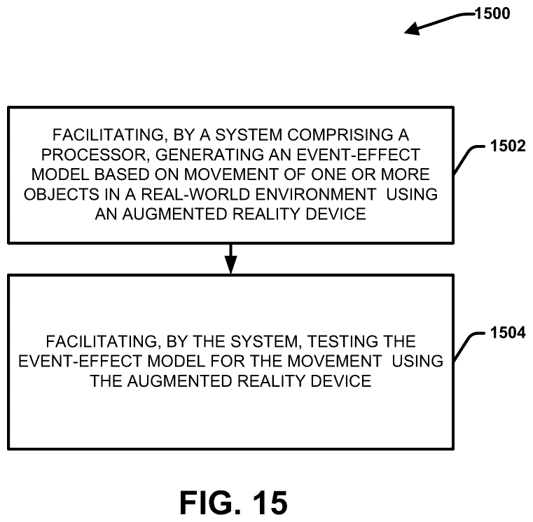

FIG. 15 presents a block diagram of another example, non-liming, computer-implemented method 1500 that facilitates prototyping applications of spatially aware smart objects in accordance with one or more embodiments. Method 1500 comprises, at 1502, facilitating, by a system comprising a processor (e.g., system 100, system 600 or the like), generating an event-effect model for a spatial interaction between objects using an AR device (e.g., AR device 102). Method 1500 further comprises facilitating, by the system, testing the event-effect model for the spatial interaction using the AR device (e.g., and testing component 612).

One or more embodiments of the disclosed subject matter can be a system, a method, and/or a computer program product at any possible technical detail level of integration. The computer program product can include a computer readable storage medium (or media) having computer readable program instructions thereon for causing a processor to carry out one or more parts of the present embodiments.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. In this regard, a computer readable storage medium as user herein can include or correspond to a non-transitory machine or computer-readable storage medium.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiment(s) can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, procedural programming languages, such as the “C” programming language or similar programming languages, and machine-learning programming languages such as like CUDA, Python, Tensorflow, PyTorch, and the like. The computer readable program instructions can execute entirely on the user's computer, partly on the user's computer, as a stand-alone software package, partly on the user's computer and partly on a remote computer or entirely on the remote computer or server using suitable processing hardware. In the latter scenario, the remote computer can be connected to the user's computer through any type of network, including a local area network (LAN) or a wide area network (WAN), or the connection can be made to an external computer (for example, through the Internet using an Internet Service Provider). In various embodiments involving machine-learning programming instructions, the processing hardware can include one or more graphics processing units (GPUs), central processing units (CPUs), and the like. For example, one or more inferencing models (e.g., multi-task inferencing models, sub-models, or components thereof) may be written in a suitable machine-learning programming language and executed via one or more GPUs, CPUs or combinations thereof. In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform part(s) of the present embodiment(s).

One or more embodiments of the present application are described herein with reference to flowchart illustrations and/or block diagrams of methods, apparatus (systems), and computer program products according to embodiments of the present application. It can be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects or processes of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present application. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession may, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In connection with FIG. 16, the systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which can be explicitly illustrated herein.

With reference to FIG. 16, an example environment 1600 for implementing various embodiments of the subject application includes a computer 1602. The computer 1602 includes a processing unit 1604, a system memory 1606, a codec 1635, and a system bus 1608. The system bus 1608 couples system components including, but not limited to, the system memory 1606 to the processing unit 1604. The processing unit 1604 can be any of various available processors. Dual microprocessors and other multiprocessor architectures also can be employed as the processing unit 1604.

The system bus 1608 can be any of several types of bus structure(s) including the memory bus or memory controller, a peripheral bus or external bus, or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13164), and Small Computer Systems Interface (SCSI).

The system memory 1606 includes volatile memory 1610 and non-volatile memory 1612, which can employ one or more of the disclosed memory architectures, in various embodiments. The basic input/output system (BIOS), containing the basic routines to transfer information between elements within the computer 1602, such as during start-up, is stored in non-volatile memory 1612. In addition, according to present innovations, codec 1635 can include at least one of an encoder or decoder, wherein the at least one of an encoder or decoder can consist of hardware, software, or a combination of hardware and software. Although codec 1635 is depicted as a separate component, codec 1635 can be contained within non-volatile memory 1612. By way of illustration, and not limitation, non-volatile memory 1612 can include read only memory (ROM), programmable ROM (PROM), electrically programmable ROM (EPROM), electrically erasable programmable ROM (EEPROM), Flash memory, 3D Flash memory, or resistive memory such as resistive random access memory (RRAM). Non-volatile memory 1612 can employ one or more of the disclosed memory devices, in at least some embodiments. Moreover, non-volatile memory 1612 can be computer memory (e.g., physically integrated with computer 1602 or a mainboard thereof), or removable memory. Examples of suitable removable memory with which disclosed embodiments can be implemented can include a secure digital (SD) card, a compact Flash (CF) card, a universal serial bus (USB) memory stick, or the like. Volatile memory 1610 includes random access memory (RAM), which acts as external cache memory, and can also employ one or more disclosed memory devices in various embodiments. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM) and so forth.

Computer 1602 can also include removable/non-removable, volatile/non-volatile computer storage medium. FIG. 16 illustrates, for example, disk storage 1614. Disk storage 1614 includes, but is not limited to, devices like a magnetic disk drive, solid state disk (SSD), flash memory card, or memory stick. In addition, disk storage 1614 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1614 to the system bus 1608, a removable or non-removable interface is typically used, such as interface 1616. It is appreciated that disk storage 1614 can store information related to an entity. Such information might be stored at or provided to a server or to an application running on an entity device. In one embodiment, the entity can be notified (e.g., by way of output device(s) 1636) of the types of information that are stored to disk storage 1614 or transmitted to the server or application. The entity can be provided the opportunity to opt-in or opt-out of having such information collected or shared with the server or application (e.g., by way of input from input device(s) 1628).

It is to be appreciated that FIG. 16 describes software that acts as an intermediary between entities and the basic computer resources described in the suitable operating environment 1600. Such software includes an operating system 1618. Operating system 1618, which can be stored on disk storage 1614, acts to control and allocate resources of the computer system 1602. Applications 1620 take advantage of the management of resources by operating system 1618 through program modules 1624, and program data 1626, such as the boot/shutdown transaction table and the like, stored either in system memory 1606 or on disk storage 1614. It is to be appreciated that the claimed subject matter can be implemented with various operating systems or combinations of operating systems.

An entity enters commands or information into the computer 1602 through input device(s) 1628. Input devices 1628 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1604 through the system bus 1608 via interface port(s) 1630. Interface port(s) 1630 include, for example, a serial port, a parallel port, a game port, and a universal serial bus (USB). Output device(s) 1636 can use some of the same type of ports as input device(s) 1628. Thus, for example, a USB port can be used to provide input to computer 1602 and to output information from computer 1602 to an output device 1636. Output adapter 1634 is provided to illustrate that there are some output devices 1636 like monitors, speakers, and printers, among other output devices 1636, which require special adapters. The output adapters 1634 include, by way of illustration and not limitation, video and sound cards that provide a means of connection between the output device 1636 and the system bus 1608. It should be noted that other devices or systems of devices provide both input and output capabilities such as remote computer(s) 1638.

Computer 1602 can operate in a networked environment using logical connections to one or more remote computers, such as remote computer(s) 1638. The remote computer(s) 1638 can be a personal computer, a server, a router, a network PC, a workstation, a microprocessor based appliance, a peer device, a smart phone, a tablet, or other network node, and typically includes many of the elements described relative to computer 1602. For purposes of brevity, only a memory storage device 1640 is illustrated with remote computer(s) 1638. Remote computer(s) 1638 is logically connected to computer 1602 through a network interface 1642 and then connected via communication connection(s) 1644. Network interface 1642 encompasses wire or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1644 refers to the hardware/software employed to connect the network interface 1642 to the bus 1608. While communication connection 1644 is shown for illustrative clarity inside computer 1602, it can also be external to computer 1602. The hardware/software necessary for connection to the network interface 1642 includes, for exemplary purposes only, internal and external technologies such as, modems including regular telephone grade modems, cable modems and DSL modems, ISDN adapters, and wired and wireless Ethernet cards, hubs, and routers.

The illustrated embodiments of the disclosure may also be practiced in distributed computing environments where certain tasks are performed by remote processing devices that are linked through a communications network. In a distributed computing environment, program modules can be located in both local and remote memory storage devices.

The illustrated embodiments of the disclosure may also be practiced in distributed computing environments where certain tasks are performed by remote processing devices that are linked through a communications network. In a distributed computing environment, program modules can be located in both local and remote memory storage devices.

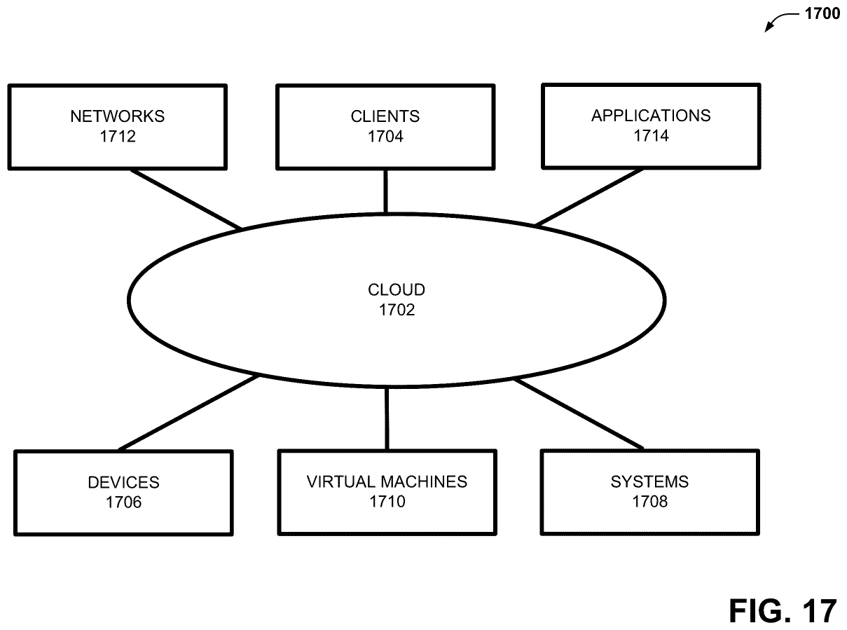

The illustrated embodiments described herein can be employed relative to distributed computing environments (e.g., cloud computing environments), such as described below with respect to FIG. 17, where certain tasks are performed by remote processing devices that are linked through a communications network. In a distributed computing environment, program modules can be located both in local and/or remote memory storage devices.

For example, one or more embodiments described herein and/or one or more components thereof can employ one or more computing resources of the cloud computing environment 1702 described below with reference to illustration 1700 of FIG. 17. For instance, one or more embodiments described herein and/or components thereof can employ such one or more resources to execute one or more: mathematical function, calculation and/or equation; computing and/or processing script; algorithm; model (e.g., artificial intelligence (AI) model, machine learning (ML) model, deep learning (DL) model, and/or like model); and/or other operation in accordance with one or more embodiments described herein.

It is to be understood that although one or more embodiments described herein include a detailed description on cloud computing, implementation of the teachings recited herein are not limited to a cloud computing environment. Rather, one or more embodiments described herein are capable of being implemented in conjunction with any other type of computing environment now known or later developed. That is, the one or more embodiments described herein can be implemented in a local environment only, and/or a non-cloud-integrated distributed environment, for example.

A cloud computing environment can provide one or more of low coupling, modularity and/or semantic interoperability. At the heart of cloud computing is an infrastructure that includes a network of interconnected aspects.

Moreover, the non-limiting systems 100 and/or 600, and/or the example operating environment 1600 of FIG. 16, can be associated with and/or be included in cloud-based and/or partially-cloud-based system.

Referring now to details of one or more elements illustrated at FIG. 17, the illustrative cloud computing environment 1700 is depicted. Cloud computing environment 1700 can comprise one or more cloud computing nodes, virtual machines, and/or the like with which local computing devices used by cloud clients 1704, such as for example via one or more devices 1706, systems 1708, virtual machines 1210, networks 1712, and/or applications 1714.

The one or more cloud computing nodes, virtual machines and/or the like can be grouped physically or virtually, in one or more networks, such as local, distributed, private, public clouds, and/or a combination thereof, collective represented by cloud 1702. The cloud computing environment 1700 can provide infrastructure, platforms, virtual machines, and/or software for which a client 1704 does not maintain all or at least a portion of resources on a local device, such as a computing device. The various elements 1706 to 1712 are not intended to be limiting and are but some of various examples of computerized elements that can communicate with one another and/or with the one or more cloud computing nodes via the cloud computing environment 1700, such as over any suitable network connection and/or type.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented in combination with one or more other program modules. Generally, program modules include routines, programs, components, data structures, and/or the like that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a memory that stores computer-executable components; and
a processor that executes the computer-executable components stored in the memory, wherein the computer-executable components comprise:
a spatial detection component that determines and tracks spatial positions and orientations of one or more objects in association with moving the one or more objects within a real-world environment; and
an interface component comprising a visual programming user interface that facilitates prototyping spatial events and corresponding effects associated with the moving of one or more objects based on the spatial positions and orientations.

2. The system of claim 1, wherein the visual programming user interface comprises an augmented reality user interface that renders via a display of an augmented reality device.

3. The system of claim 2, wherein the spatial detection component determines and tracks the spatial positions and orientations based on sensor data captured by one or more sensors that are part of, or communicatively coupled to, the augmented reality device.

4. The system of claim 3, wherein the spatial detection component determines and tracks the spatial positions and orientations using one or more spatial positioning markers associated with the one or more objects and a spatial positioning marker-based tracking process.

5. The system of claim 2, wherein the real-world environment comprises an environment within a field-of-view of the display, and wherein the interface component renders the visual programming user interface via the display in association with the moving of the one or more objects.

6. The system of claim 5, wherein the computer-executable components further comprise:
a spatial event and effect creation component that generates spatial event information defining a spatial event corresponding to a defined spatial position, orientation or movement of the one or more objects, wherein the spatial event information is generated based on first user input received via the visual programming user interface, and wherein the spatial event is defined based on positioning of the one or more objects at the defined spatial position or orientation.

7. The system of claim 6, wherein the spatial event and effect creation component further generates event effect information defining an effect of the spatial event based on second user input received via the visual programming user interface defining the effect, and wherein the event effect and creation component generates an event-effect model associated with the moving of the one or more objects based on the spatial event information and the effect information.

8. The system of claim 7, wherein the first user input indicates the defined spatial position or orientation in association with the positioning of the one or more objects at the defined spatial position or orientation within the field-of-view of the display, and wherein the interface component generates a first virtual proxy representative of the spatial event and renders the virtual proxy via the display in association reception of the first user input.

9. The system of claim 8, wherein the interface component generates a second virtual proxy representative of the effect and renders the second virtual proxy via the display in association with reception of the second user input, and wherein the event effect and creation component generates a mapping between the spatial event and the effect within the event-effect model based on reception of third user input via the visual programming user interface connecting the first virtual proxy to the second virtual proxy.

10. The system of claim 7, wherein the event effect information defines a virtual asset representative of the effect and enables control of a rendering position or a behavior of the virtual asset via the display in response to a detection of the spatial event.

11. The system of claim 10, wherein the virtual programming user interface facilitates at least one of selecting the virtual asset from a group of predefined virtual assets or creating the virtual asset using one or more virtual asset creation tools.

12. The system of claim 10, wherein the moving corresponds to a first moving of the one or more objects performed in association with a creation mode of the visual programming user interface, and wherein the computer-executable components further comprise:
a testing component that executes a testing mode of the visual programming user interface using the augmented reality device, wherein the testing mode facilitates testing of the spatial event and the effect in accordance with the event-effect model in association with a second moving of the one or more objects within the field-of-view of the display.

13. The system of claim 12, wherein the spatial detection component determines and tracks updated spatial positions and orientations of the one or more objects in association with the second moving, and wherein the interface component renders the virtual asset via the display in accordance with the event-effect model in response to the detection of the spatial event by the spatial detection component based on an updated spatial position or orientation of the updated spatial positions and orientations corresponding to the defined spatial position or orientation.

14. A method, comprising:
determining and tracking, by a system comprising a processor, spatial positions and orientations of one or more objects in association with moving the objects within a field-of-view of a display of an augmented reality device; and
rendering, by the system via the display, a visual programming user interface that facilitates prototyping spatial events and corresponding effects associated with the moving of the one or more objects based on the spatial positions and orientations.

15. The method of claim 14, further comprising:
generating, by the system, spatial event information defining a spatial event corresponding to a defined spatial position, orientation or movement of the one or more objects based on first user input received via the visual programming user interface defining the spatial event in association placement of the one or more objects at the defined spatial position or orientation.

16. The method of claim 15, further comprising:
generating, by the system, effect information defining an effect of the spatial event based on second user input received via the visual programming user interface defining the effect; and
generating, by the system, an event-effect model associated with the moving of the one or more objects based on the spatial event information and the effect information.

17. The method of claim 16, wherein the effect information defines a virtual asset representative of the effect and is usable to control a rendering position or a behavior of the virtual asset via the display in response to a detection of the spatial event.

18. The method of claim 17, wherein the moving corresponds to a first moving of the one or more objects performed in association with a creation mode of the visual programming user interface, and wherein the method further comprises:
executing, by the system, a testing mode of the visual programming user interface using the augmented reality device, wherein the testing mode facilitates testing the spatial event and the effect in accordance with the event-effect model in association with a second moving of the one or more objects within the field-of-view of the display;
determining and tracking, by the system, new spatial positions and orientations of the one or more objects in association with the second moving; and
rendering, by the system, the virtual asset via the display in accordance with the event-effect model in response to the detection of the spatial event based on a new spatial position or orientation corresponding to the defined spatial position or orientation.

19. A non-transitory machine-readable medium, comprising executable instructions that, when executed by a processor facilitate performance of operations, comprising:
determining and tracking spatial positions and orientations of one or more objects in association with moving the objects within a field-of-view of a display of an augmented reality device; and
providing a visual programming user interface via the display that facilitates prototyping spatial events and corresponding effects associated with the one or more objects.

20. The method of claim 19, wherein determining and tracking comprises determining and tracking the relative spatial positions based on sensor data captured by one or more sensors of the augmented reality device.
